(19) United States
(12) Patent Application Publication
(10) Pub. No.: US 2016/0364960 A1
(43) Pub. Date: Dec. 15, 2016

(54) SYSTEMS AND METHODS FOR ULTRASONICALLY INDUCED TACTILE STIMULI IN AN ENTERTAINMENT SYSTEM

(71) Applicant: Elwha LLC, Bellevue, WA (US)

(72) Inventors: Jesse R. Cheatham, III, Seattle, WA (US); Roderick A. Hyde, Redmond, WA (US); Muriel Y. Ishikawa, Livermore, CA (US); Jordin T. Kare, San Jose, CA (US); Craig J. Mundie, Seattle, WA (US); Nathan P. Myhrvold, Bellevue, WA (US); Robert C. Petroski, Seattle, WA (US); Eric D. Rudder, Mercer Island, WA (US); Desney S. Tan, Kirkland, WA (US); Clarence T. Tegreene, Mercer Island, WA (US); Charles Whitmer, North Bend, WA (US); Andrew Wilson, Seattle, WA (US); Jeannette M. Wing, Bellevue, WA (US); Lowell L. Wood, JR., Bellevue, WA (US); Victoria Y.H. Wood, Livermore, CA (US)

(21) Appl. No.: 14/734,863

(22) Filed: Jun. 9, 2015

(51) Int. Cl. G08B 6/00; B06B 1/02; G01S 15/46

(52) U.S. Cl. CPC G08B 6/00; G01S 15/46; B06B 1/0215

(57) ABSTRACT

The present disclosure provides systems and methods for generating a haptic sensation, such as a tactile stimuli, using parametric ultrasound on a site of an object. An entertainment device may be associated with a parametric ultrasonic transmitters subsystem configured to transmit first and second ultrasonic pulses that intersect proximate a site of a user and generate an acoustic wave at a beat frequency of the first and second ultrasonic pulses. The beat frequency may be selected such that the generated acoustic wave induces a haptic sensation at the identified site of the user.

If an Application Data Sheet (“ADS”) has been filed on the filing date of this application, it is incorporated by reference herein. Any applications claimed on the ADS for priority under 35 U.S.C. §§119, 120, 121, or 365(c), and any and all parent, grandparent, great-grandparent, etc., applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 U.S.C. §119(e) for provisional patent applications, for any and all parent, grandparent, great-grandparent, etc., applications of the Priority Application(s)).

### PRIORITY APPLICATIONS

None.

### RELATED APPLICATIONS

If the listings of applications provided herein are inconsistent with the listings provided via an ADS, it is the intent of the Applicants to claim priority to each application that appears in the Priority Applications section of the ADS and to each application that appears in the Priority Applications section of this application.

All subject matter of the Priority Applications and the Related Applications and of any and all parent, grandparent, great-grandparent, etc., applications of the Priority Applications and the Related Applications, including any priority claims, is incorporated herein by reference to the extent such subject matter is not inconsistent herewith.

This application is related to U.S. patent application Ser. No. 14/203,401, filed on Mar. 10, 2014, titled SYSTEMS AND METHODS FOR ULTRASONIC POSITION AND MOTION DETECTION, and to U.S. patent application Ser. No. 14/280,463, filed on May 16, 2014, titled SYSTEMS AND METHODS FOR ULTRASONIC VELOCITY AND ACCELERATION DETECTION, which applications are hereby incorporated by reference in its entirety.

### TECHNICAL FIELD

This disclosure relates to systems and methods for imaging an object within a region and inducing a haptic sensation on a site of the object using parametric ultrasound. Specifically, this disclosure provides systems and methods for generating a haptic sensation for use in combination with entertainment and/or infotainment devices.

### SUMMARY

A system may use parametric ultrasound to induce a haptic sensation in or on a user. For example, the haptic sensation may include a tactile stimuli at an identified site of a user. The system may direct multiple ultrasonic pulses toward a point proximate a user of the system. Mixing may occur between the ultrasonic pulses, at the location where the ultrasonic pulses intersect. A new, lower frequency pulse may be generated at the sight of the mixing ultrasonic pluses. The generated low frequency pulse may be at a beat frequency of the original ultrasonic pulses. A beat frequency may be generated at a sufficiently low frequency to induce tactile stimuli in human skin (e.g., 10 Hz to 500 Hz).

The type and/or quality of the induced tactile stimuli (or other haptic sensation) may be controlled or adjusted by altering either the amplitude, frequency, or duration of the ultrasonic pulses. It may be calibrated to induce a multiplicity of different stimuli (e.g., touch, stroke, brush, impulse, or motion). The induced tactile stimuli may also be directed toward an identified area of interest (i.e., a portion or site of/at/on a user), such as a person's hands, arms, legs, feet, lips, face, or head.

A system using parametric ultrasound to induce tactile stimuli may use compressed sensing, or other sensing and imaging techniques, to generate image data. The image data may be useful in directing the operation of the parametric ultrasound.

A system that uses parametric ultrasound to provide induced tactile stimuli may also utilize a dual modality sensor to generate image data. The system may use a first modality to generate coarse image data of an object or region of interest (e.g., a user of an entertainment system). The system may then use this coarse image data to identify portions of interest of the object. The portion of interest may, as a specific example, be a site on a user such as hands, arms, legs, or feet. The system may use a second modality to generate fine image data of the identified portions of interest. Compressed sensing may be used to generate or enhance either the coarse image data or the fine image data.

For example, in various embodiments, a system may include one or more ultrasonic transmitters and/or receivers to implement a first modality. In some embodiments the transmitter(s) and/or receiver(s) may be embodied as one or more transceivers. An ultrasonic transmitter may be configured to transmit ultrasound into a region bounded by one or more surfaces. The ultrasonic receiver may receive direct ultrasonic reflections from one or more objects within the region. As described in detail below, the system may use the ultrasonic transmitters and/or receivers, in combination with compressed sensing, to generate coarse image data of an object and identify, based on the coarse image data, portions of interest of the object.

For instance, in certain examples, a system may also be configured to receive, via an electromagnetic receiver, an electromagnetic reflection from an object within a region. The system may generate fine image data of identified portions of interest using the received electromagnetic reflection. For example, after a portion of interest has been identified via coarse image data, the system may receive electromagnetic radiation from the identified portion of interest and use compressed sensing techniques to generate image data with greater resolution than available in the coarse image data (referred to herein as fine image data).

Either of the two modalities discussed above (i.e., electromagnetic imaging and ultrasound) can be utilized by the system to generate either the fine image data or the coarse image data. For example, a first embodiment may utilize ultrasound to generate coarse image data and electromagnetic imaging to generate fine image data, whereas a second embodiment may utilize electromagnetic imaging to generate coarse image data and ultrasound to generate fine image data. Compressed sensing may be used to generate or enhance either or both modalities.

The image data may be useful in directing the operation of the parametric ultrasonic transceiver used to induce haptic sensation(s) such as a tactile stimuli. It may be useful to determine the location of a user or target for providing induced haptic sensation. For example, a system may utilize generated image data to determine the location of a user and/or site(s) of interest on the user for providing induced tactile stimuli. Then the system may be able to induce calibrated tactile stimuli at the identified site(s) of interest.

The foregoing summary is illustrative only and is not intended to be limiting in any way. In addition to the illustrative aspects, embodiments, and features described above, further aspects, embodiments, and features are demonstrated with reference to the drawings and the following detailed description.

### BRIEF DESCRIPTION OF THE DRAWINGS

FIG. 1A illustrates a positioning system transmitting ultrasound toward three persons within a bounded region.

FIG. 1B illustrates a direct ultrasonic reflection received by the positioning system and the resulting “image” generated by the positioning system.

FIG. 2A illustrates a positioning system rebounding ultrasound off the wall and then toward the three persons.

FIG. 2B illustrates a side view of the positioning system rebounding the ultrasound off the wall and then toward the three persons.

FIG. 3A illustrates a plurality of ultrasonic reflectors configured to facilitate the transmission, reflection, and/or reception of rebounded ultrasound by the positioning system.

FIG. 3B illustrates a plurality of active ultrasonic reflectors configured to facilitate the transmission, reflection, and/or reception of rebounded ultrasound by the positioning system.

FIG. 4A illustrates an actively controlled ultrasonic reflector in a first position configured to pivot with respect to the wall on which it is mounted to facilitate the transmission, reflection, and/or reception of rebounded ultrasound by the positioning system.

FIG. 4B illustrates the actively controlled ultrasonic reflector in a second position.

FIG. 5 illustrates a block diagram of a positioning system, according to one embodiment.

FIG. 6 illustrates a flow chart of a method for generating positional data describing a relative position of one or more objects within a region.

FIG. 7A illustrates an ultrasonic system transmitting and receiving reflected ultrasound from a stationary object.

FIG. 7B illustrates an ultrasonic system transmitting ultrasound at a first frequency and receiving reflected ultrasound at a second frequency from an object moving away from the ultrasound system.

FIG. 7C illustrates an ultrasound system transmitting ultrasound at a first frequency and receiving reflected ultrasound at a second frequency from an object moving toward the ultrasound system.

FIG. 7D illustrates an ultrasonic system transmitting and receiving reflected ultrasound from a stationary object, similar to FIG. 7A.

FIG. 7E illustrates a timing delay in a reflected ultrasound from an object as moving away from an ultrasound system.

FIG. 8 illustrates ultrasound rebounded off of a reflector prior to being reflected by an object moving away from an ultrasonic receiver.

FIG. 9. illustrates an electromagnetic position detection system used in conjunction with an ultrasound velocity and/or acceleration detection system.

FIG. 10 illustrates ultrasound reflected and/or rebounded from one or more auxiliary reflectors.

FIG. 11 illustrates a plurality of ultrasonic systems for determining velocity and/or acceleration information from multiple directions.

FIG. 12 illustrates a method for determining velocity and/or acceleration information associated with a moving object.

FIG. 13A illustrates a dual modality positioning system transmitting and receiving ultrasound reflected off a person standing within a bounded region.

FIG. 13B illustrates a dual modality positioning system generating coarse image data of an object based on received ultrasonic reflections.

FIG. 13C illustrates a dual modality positioning system identifying several portions of interest on an object based on coarse image data generated from ultrasonic reflections.

FIG. 14 illustrates a dual modality positioning system using electromagnetic reflections in conjunction with ultrasound to receive additional image information from identified portion of interests.

FIG. 15 illustrates a dual modality positioning system generating fine image data of portions of interest on a person.

FIG. 16 illustrates a method for generating an image using ultrasound and electromagnetic radiation.

FIG. 17 illustrates another method for generating an image using ultrasound and electromagnetic radiation.

FIG. 18 illustrates a method for resolving ambiguities in an image using ultrasound and electromagnetic radiation.

FIG. 19A illustrates a six pixel image that may have been generated using either ultrasound and/or electromagnetic radiation.

FIG. 19B illustrates five single value image captures that may be used to approximate one higher resolution image.

FIG. 19C illustrates an approximation of a higher resolution image from multiple low resolution images using compressed sensing.

FIG. 20A illustrates ultrasound being used to capture multiple small images of a person.

FIG. 20B illustrates multiple small images that may be pieced together to form a single larger image.

FIG. 21A illustrates ultrasound being used to take multiple low resolution images that may be used to approximate a higher resolution image.

FIG. 21B illustrates multiple low resolution images that may be averaged together using compressed sensing techniques.

FIG. 21C illustrates a higher resolution image that was approximated from multiple low resolution images.

FIG. 22 illustrates an image generated using compressed sensing.

FIG. 23 illustrates a method for using compressed sensing to generate image data.

FIG. 24A illustrates a parametric ultrasonic transmitter subsystem for providing haptic feedback to a user of an entertainment system.

FIG. 24B illustrates the generation of a sonic pulse, used to provide haptic feedback, at a beat frequency of two intersecting ultrasonic pulses.

FIG. 25A illustrates a user initiating virtual interaction with a displayed image of an entertainment system.

FIG. 25B illustrates the user virtually interacting with the displayed image from the entertainment system.

FIG. 25C illustrates the entertainment system providing haptic feedback to enhance the virtual interaction of the user with the entertainment system.

### DETAILED DESCRIPTION

Entertainment systems are often rated on their ability to both interact with and entertain users of the entertainment system. The interaction between the user and the entertainment system may involve a multiplicity of forms. For example, the entertainment system may interact with the user visually, audibly, or haptically through physical contact with a controller or other device. The user, in turn, may interact with the entertainment system through use of a remote control or a video game controller, or through some other means. The ability of the system to interact with the user may be enhanced through the ability to interact with the user and provide haptic feedback to the user without the need for physical contact between the user and the entertainment system or some peripheral of the entertainment system (e.g., a video game controller). This type of haptic feedback may be generated using parametric ultrasound.

A system may use parametric ultrasound to generate a low frequency pulse at a point proximate the user of the system. Pulses at various frequencies (e.g., 20 Hz to 300 Hz) may be felt by the user as a haptic sensation (e.g., an induced tactile sensation or a touch). By altering the frequency, amplitude, or duration of the ultrasonic pulses the form, type, and/or quality of the tactile sensation may be altered. It may be possible to create a multiplicity of different sensations through the manipulation of the ultrasonic pulses. For example, in some embodiments the system may be calibrated to generate a pulse that feels like a touch, a brush, a stroke, a pinch, an impulse, or even a kinesthetic sensation.

The low frequency pulse may be generated by directing a first ultrasonic pulse along a vector relative to the user of the entertainment system and a second ultrasonic pulse along a different vector relative to the user of the ultrasonic system. The two ultrasonic pulses may intersect at a point proximate a location or site identified for receiving an induced tactile stimuli. Ultrasonic pulses behave nonlinearly in air and tissue. The nonlinear behavior of the ultrasonic pulses may cause mixing to occur at the point where the pulses intersect. The mixing of the ultrasonic pulses may generate a new low frequency pulse at a beat frequency of the original ultrasonic pulses.

As used herein an ultrasonic pulse may be any duration and/or include any number of shorter pulses. For example, an ultrasonic pulse may be a continuous transmission of ultrasound. As another example, an ultrasonic pulse may be a continuous ultrasound transmission lasting for a finite period of time. As another example, an ultrasonic pulse may comprise a plurality of shorter pulses having the same or different frequencies, phases, and/or amplitudes.

A system may be developed to provide haptic feedback to a user of an entertainment system using parametric ultrasonic techniques. To provide haptic feedback to the user the system may also require various subsystems or modules to facilitate haptic feedback to a user. For example, a system for providing haptic feedback to a user may include a radiation receiver, a position module, an identification module, an entertainment device interface, a parametric ultrasonic transmitter subsystem and/or a haptic feedback selection module. The various modules and subsystems may be useful in determining characteristic data about the user that may influence the state of the entertainment system.

Accordingly, the state of the entertainment system may determine the type of haptic feedback to provide to the user. For example, the system may generate data relevant to the position, posture, motion, stance, or location of the user. The data may be generated for one user or many. The data may refer to sites of interest on or in the user. For example, the system may track the user's hands, feet, arms, legs, head, eyes, lips, or other regions of interest. The data relevant to these sites of interest may be instrumental in determining the state of the entertainment system. Depending on the state of the entertainment system the type and placement of the haptic feedback may be determined or adjusted.

For example, in one embodiment the system may track the movement of the user's hands. If the user waves at the entertainment display interface the entertainment system may move from a standby state to an active state. Then the system may provide haptic feedback to the user to confirm the change. From the user's perspective, this may involve turning on the entertainment display interface or displaying a selection screen. The haptic feedback may be felt by the user and interpreted as a touch on the user's hand, confirming that the system is now active. In an embodiment, the system may provide haptic feedback to confirm receipt or execution of a command or selection delivered by the user to the entertainment display interface.

The system may provide an induced haptic sensation to the user in any way that is useful for interacting with the user. In one embodiment the entertainment system may be used to display a video or movie. Then induced haptic sensations may be used to enhance the presentation of the video. For example, haptic sensations may be used to inform the user when the video is starting or stopping. In another embodiment the entertainment system may be used to play an exercise game. Then the system may use induced haptic sensations to inform the user when to step or move during a workout. The induced haptic sensations may be intended to encourage the user to pick up the speed or confirm the completion of a workout.

There may be embodiments where multiple users interact virtually through the entertainment system display interface. The system may provide haptic sensations to each player if they score a point or may induce haptic sensations to provide feedback when a user loses a life or engages another player. It may even be possible for players to direct haptic sensations towards one another during the course of, or as part of, a game. Other embodiments may interact similarly with a single user.

In still another embodiment, a user may engage in a driving simulation on an entertainment system. Induced haptic sensations may be used to provide a sense of motion to the user. They may be used to simulate a turn, wind resistance or other sensations connected with driving. These examples are meant to be illustrative and not restrictive. They are meant to show the breadth of interaction where an entertainment system may use haptic feedback to enhance the experience of a user, convey information, induce user participation, etc.

A radiation receiver may be used to collect information about a bounded region such as a room. The receiver may receive electromagnetic radiation and/or ultrasonic radiation. The received radiation may be ambient radiation from the bounded region or it may be reflected radiation from a transmitter. The radiation receiver may convert the received radiation into an image or image data. The system may use various techniques for generating image data suitable for providing induced haptic sensations to a user.

A system may utilize compressed sensing techniques to generate image data suitable for providing induced haptic sensations to a user. For example, a system may use low resolution imaging (e.g., either ultrasound or electromagnetic radiation) to capture multiple overlapping images, where each image represents only a portion of the object of interest. The images may then be combined using compressed sensing techniques to approximate a single, higher resolution image of the entire object. A perfect approximation of the image may require, in some embodiments, thousands or millions of low resolution image captures, whereas a good or adequate approximation of the image may require only a small percentage of the required number of low resolution images for the perfect approximation. Accordingly, image data for an object may be adequately approximated by applying compressed sensing techniques to a relatively small number of low resolution images.

Examples of “compressed sensing,” including various applications of compressed sensing, methods of performing compressed sensing, uses for compressed sensing, and variations of compressed sensing that are applicable to many of the embodiments described herein, are described in N. P. Pitsianis et al., “Compressive Imaging Sensors,” Proc. of SPIE Vol. 6232, 62302A (2006); Mark A. Neifeld et al., “Optical Architectures for Compressive Imaging,” Applied Optics Vol. 46, No. 22, 5293 (2007); and Justin Romberg et al., “Compressed Sensing: A Tutorial,” IEEE statistical signal workshop (2007), available at http://users.ece.gatech.edu/justin/ssp2007/ssp07-cs-tutorial.pdf, all of which are incorporated herein by reference in their entireties.

As a specific example, an ultrasonic transmitter may be used to direct ultrasound at a small portion of a region of interest. The ultrasonic reflections may be recorded by an ultrasonic receiver. The reflections may be used to generate a very low resolution image of a small portion of the area of interest. This process may then be repeated multiple times for small, possibly overlapping, areas of interest until all or almost all parts of the larger region of interest are covered by one or more of the smaller, low resolution images. A processor may run a compressed sensing algorithm to combine the small low resolution images into an approximation of the region of interest.

In some embodiments the low resolution images may be generated using electromagnetic reflections or ambient sources of electromagnetic radiation such as light or infrared radiation.

In some embodiments the images may be generated in color. In other embodiments the images may be generated in grayscale, infrared, UV, high dynamic range, or another false color representation.

A system may utilize a dual modality sensor system to generate image data. For instance, a system may utilize two imaging modalities for imaging an object at two different resolutions. The object may represent a user or site on a user of an entertainment system. That is, the system may utilize a first modality (e.g., either ultrasound or electromagnetic radiation) to generate image data of an object at a first resolution. The data may be generated directly or through compressed sensing techniques. The data at the first resolution may be used to determine the position of the object or user. The system may then utilize the other modality or compressed sensing to generate image data of portions of interest on the object (not necessarily the entire object) at a second resolution, where the second resolution is higher than the first resolution. The portions of interest may be sites of interest where the system could provide induced haptic sensation to the user (e.g., hands, feet, arms, legs, head, nose, chin, ears, lips). Accordingly, the dual modalities may be used to generate a coarse (i.e., lower resolution) image of the entire object using a first modality, identify portions of interest on the object, and then generate a fine (i.e., higher resolution) image of the portions of interest using a second modality.

As a specific example, a system may transmit ultrasound, via a first ultrasonic transmitter, into the region. An ultrasonic receiver may receive ultrasonic reflections of the transmitted ultrasound from a plurality of sites on the object within the bounded region. A processor may use compressed sensing to generate coarse image data of the object (i.e., a user of an entertainment system) at a first resolution based on the received ultrasonic reflections. The system may then identify a portion of interest on the object (i.e., a site of interest on the user) based on the coarse image data. Electromagnetic radiation may be received from the identified portion of interest on the object. Fine image data of the portion of interest on the object may be generated at a second resolution based on the received electromagnetic radiation. The second resolution may be greater than the first resolution. In some embodiments, the first resolution may be greater than the second resolution. The image data of the portion of interest may be used to provide induced haptic stimuli to sites of interest on the user.

In some embodiments, a kinematic value may be determined that is associated with the portion of interest on the object based on at least one of the received electromagnetic radiation and the received ultrasonic reflections. Similarly, in some embodiments, the state of an entertainment device may be modified based on the determined kinematic value associated with the portion of interest on the object.

As a specific example, a kinematic value may be assigned to the hand of a user of an entertainment system. Rapid changes in the kinematic value of the person's hand may trigger a change in state of the entertainment system. For example, the system may determine that the user is waving at the entertainment display interface and respond by inducing a tactile stimuli at a site of a user to acknowledge the user's wave.

In some embodiments, the coarse image data described above may be generated based on the received electromagnetic reflections and the fine image data may be generated based on the received ultrasonic reflections. In some embodiments either the coarse image data or the fine image data or both may be generated using compressed sensing. In any of the various embodiments described herein, the received electromagnetic radiation may be generated by the system, by another system, or by an auxiliary electromagnetic radiation source, and/or may comprise ambient electromagnetic radiation, such as light.

In some embodiments, one imaging modality may be used to resolve an ambiguity, such as ghost images, in image data generated using another imaging modality. For example, an image generated using ultrasound imaging technologies may have a ghosting image ambiguity that can be resolved using an electromagnetic imaging technology (or even just an electromagnetic position/distance detection technology).

For example, a system may include one or more ultrasonic transmitters and/or receivers, as well as one or more electromagnetic transmitters and/or receivers. Each of these different modalities may capture image data at different resolutions. The system may generate non- or less-important image data at a lower resolution while capturing important image data at a higher resolution. In some embodiments, generating only a portion of the image at a higher resolution, using compressed sensing or other means, may allow the system to process the image data faster and in a more compressed manner while still providing high resolution of portions of interest.

For example, a low resolution image may be generated from ultrasonic reflections using compressed sensing techniques. Then a high resolution image may be generated of the specific areas of interest using an electromagnetic receiver.

In some embodiments, the transmitter(s) and/or receiver(s) may be embodied as one or more transceivers. The ultrasonic transmitter(s) and/or receiver(s) may be operated by the system concurrently with the electromagnetic receiver(s) or in sequential order before or after the electromagnetic receiver(s). The ultrasonic transmitter(s) and receiver(s) may be used in combination with the electromagnetic receiver to generate image data.

One or more of the electromagnetic and/or ultrasonic transmitters, receivers, and/or transceivers may comprise a piezoelectric transducer that may be part of a single transducer system or an array of transducers. In some embodiments, the transducers may comprise or be made from metamaterials. A flat sub-wavelength array of ultrasonic transducers may be used in conjunction with the embodiments described herein, such as those utilizing arrays of metamaterials.

The dual modality sensor system may be configured to utilize different frequency spectrums. An ultrasonic transmitter used on such a system may be configured to transmit ultrasound into a region bounded by one or more surfaces. The ultrasound may be between 20 kHz and 250 kHz. In one embodiment, the ultrasound is specifically between 35 kHz and 45 kHz. An electromagnetic transmitter and/or receiver may also be used on such a system to transmit and/or receive a range of electromagnetic radiation frequencies. For example, a system may be configured to use electromagnetic microwave, terahertz, infrared, visible, and/or ultraviolet radiation. A dual modality sensor system may use the two modalities to produce more detailed image data and/or to correct ambiguities introduced by one of the modalities.

For example, the system may use a first modality to generate coarse image data of an object, and, to get more detailed data about an identified portion of interest, the system may use a second modality to generate fine image data of the identified portion of the object. For example, if the first modality produces an image with a low resolution of an object, the second modality may be used to provide a higher resolution of portions of interest on the object. Another embodiment may include a first modality that introduces an ambiguity into the image data. To correct the ambiguity, the system may use a second modality that is not susceptible to the same type of ambiguity.

For example, the system may include one or more ultrasonic transmitters and/or receivers. The system may use the ultrasonic receivers and/or transmitters to generate coarse image data. For instance, an ultrasonic transmitter may be configured to transmit ultrasound into a region. An ultrasonic receiver may receive ultrasonic reflections from one or more objects within the region. Based on these received ultrasonic reflections, the system may generate coarse image data of the one or more objects via a processor. The data may be generated directly or through compressed sensing techniques

The system may identify portions of interest on the object using the coarse image data. For example, the system may identify a person's hand, finger, arm, leg foot, toe, torso, neck, head, mouth, lip, and/or eye. The portion of interest identified may be based on a state of an entertainment device. Once one or more portions of interest have been identified, the system may use a second modality (e.g., electromagnetic radiation) to gather further details about the portion of interest.

For instance, the system may also use electromagnetic receiver(s) and/or transmitter(s). The system may generate fine image data of the identified portions of interest using received electromagnetic reflections. For example, after a portion of interest has been identified using the coarse image data, the system may receive electromagnetic radiation from the identified portion of interest and generate a higher resolution image of the identified portions of interest.

In some embodiments, a second modality may be used to resolve at least one ambiguity inherent in or caused by the usage of the first modality. For example, image data generated using the first modality may include an ambiguity. For example, image data generated via ultrasound may have ghost images inherent in the image data. In such an example, a second modality (e.g., electromagnetic radiation) may be utilized by the system to resolve the ambiguity introduced by the first modality. For instance, received electromagnetic radiation can be utilized by the system to remove ghost images in the image data generated using the ultrasonic reflections.

Either of the two modalities discussed above (i.e., electromagnetic imaging and ultrasound) may be utilized by the system to generate either fine image data or coarse image data. In addition, the image data in either modality may be generated directly or using compressed sensing. For example, a first embodiment may utilize ultrasound in combination with compressed sensing to generate coarse image data and electromagnetic imaging to generate fine image data, whereas a second embodiment may utilize electromagnetic imaging to generate coarse image data and ultrasound to generate fine image data.

A kinematic value associated with the object or a specific portion of interest on the object may be determined. The kinematic value of an object may comprise the position, velocity, and/or acceleration of the object. The kinematic values may be based on the received electromagnetic radiation and/or the received ultrasonic reflections.

In some embodiments, the direct ultrasound may be reflected from a first portion of an object and the rebounded ultrasound may be reflected from a second, different portion of the object. Positional data may be determined using the received ultrasonic reflections. Direct positional data may correspond to a first directional component of the position of the object and the rebounded positional data may correspond to a second directional component of the position of the object. Similarly, one or more direct and/or rebounded ultrasonic reflections may be used to determine velocity and/or acceleration. For example, velocity and/or acceleration information may be determined using a Doppler shift that corresponds to a motion of the reflecting object.

In some embodiments, received ultrasonic reflections (direct or rebounded) may be used to determine positional data. Positional data sampled at various times may be used to determine and/or estimate current and/or future velocity and/or acceleration information associated with an object. In other embodiments, as described herein, velocity and/or acceleration information may be calculated based on a detected shift in ultrasound reflected by an object. For example, a system may detect a Doppler shift in ultrasound reflected by an object relative to the transmitted ultrasound. A shift to a longer wavelength may indicate that the object is moving away from the ultrasonic receiver. A shift to a shorter wavelength may indicate that the object is moving toward the ultrasonic receiver. The detected shift may be related to a frequency shift, a wavelength shift, a phase shift, a time-shifted reflection, and/or other ultrasonic shift.

Any number of direct and/or rebounded ultrasonic reflections may be obtained from one or more objects within a region to obtain velocity and/or acceleration data over a period of time and/or to obtain more accurate velocity and/or acceleration data with multiple data points. The transmitted ultrasound may be transmitted as directional or non-directional ultrasonic pulses, continuously, in a modulated (frequency, amplitude, phase, etc.) fashion, and/or other format. The ultrasonic transmissions may be spaced at regular intervals or on demand, and/or based on the reception of a previously transmitted ultrasonic transmission. Direct and rebounded ultrasound pulses may be transmitted at the same time, or either one can be transmitted before the other.

Rebounded ultrasonic reflections may be defined as ultrasonic reflections that, in any order, reflect off at least one surface in addition to the object. For example, the rebounded ultrasonic reflections may be reflected off any number of surfaces and/or objects (in any order) prior to being received by the ultrasonic receiver.

A mapping or positioning system may generate positional data associated with one or more of the object(s) based on the direct ultrasonic reflection(s) and/or the rebounded ultrasonic reflection(s). Positional data may be generated using compressed sensing. The positional data may comprise a centroid of the objects, a two-dimensional mapping of the object, an image of the object, a false-color representation of the object, an information representation (blocks, squares, shadows, etc.) of the object, a three-dimensional mapping of the object, one or more features of the object, and/or other information.

The velocity and/or acceleration data may be defined with respect to one or more surfaces of the region, the ultrasonic velocity/acceleration system, a receiver of the system, and/or a transmitter of the system. The one or more objects within the region may comprise machinery, robots, furniture, household property, people in general, gamers, human controllers of electronic devices, electronic devices, fixtures, and/or other human or non-human objects.

The object may comprise a specific portion of a person, such as a hand, finger, arm, leg, foot, toe, torso, neck, head, mouth, lip, and/or eye. In some embodiments, rebounded ultrasonic transmissions may be reflected off an ultrasonic reflector disposed within the room. In some embodiments, the ultrasonic reflectors may be mounted and/or otherwise positioned within the region. In other embodiments, the ultrasonic reflectors may be held, worn, and/or otherwise in the position of the user or operator of the ultrasonic positioning system. The ultrasonic reflectors may modify a characteristic of the reflected ultrasound, facilitating the identification of the received rebounded ultrasonic reflections.

Ultrasonic reflectors may comprise passive, active, and/or actively moved/pivoted ultrasonic reflectors for controlling the direction in which ultrasound rebounds and/or otherwise travels within the region. For example, the ultrasonic reflector may be configured to modify one or more of the frequency, phase, and/or amplitude of the rebounded ultrasound. The modified characteristic may facilitate the differentiation of the direct ultrasonic reflections and the rebounded ultrasonic reflections. In some embodiments the direct and rebounded signals can be differentiated using knowledge of the transmission or reception directions of the respective beams. In some embodiments, the direct and rebounded signals can be differentiated using knowledge of the time-of-flight of the respective beams. In some embodiments, the direction of a reflected beam (and hence directional characteristics of its delivered positional information) can be determined by knowledge of the orientation of the reflecting surface and its reflective characteristics. For example, ultrasonic reflection from a surface may be dominated by specular reflection, thereby allowing straightforward determination of the rebound geometry.

The mapping or positioning system may also generate velocity and/or acceleration data using the rebounded ultrasonic reflection of the object(s) from the one or more surfaces. It will be appreciated that a rebounded ultrasonic reflection from a surface may be rebounded off the surface first and then the object, or off the object first and then the surface.

The system may then generate enhanced velocity and/or acceleration data by combining the direct velocity and/or acceleration data and the rebounded velocity and/or acceleration data. The enhanced velocity and/or acceleration data may be a concatenation of the direct and rebounded velocity and/or acceleration data or a simple or complex function of the direct and rebounded velocity and/or acceleration data.

For example, in one embodiment, the direct and rebounded velocity and/or acceleration data may comprise only time-of-flight information, which, based upon air sound-speed, can be converted to transit distance information for each beam. In such embodiments, the direct velocity and/or acceleration data provides a range from the transceiver to the object, i.e., leaving the velocity and/or acceleration undefined along a two-dimensional spherical surface. Each potential object position along this spherical surface leads, e.g., assuming specular reflections, to a distinct time-of-flight for the rebounded beam from one surface (wall, ceiling, floor); this restricts the locus of possible velocities and/or accelerations of the object to a one-dimensional arc along the spherical surface, thereby improving the velocity and/or acceleration estimate(s).

The system can further refine the velocity and/or acceleration data by analyzing rebound data from a second surface. In the current example, each potential object position along the spherical surface (obtained by the time-of-flight of the direct beam) defines a first time-of-flight for ultrasound rebounded from the first surface and a second time-of-flight for ultrasound rebounded from the second surface; knowledge of both times-of-flight determines the object's position. It is clear that time-of-flight data from other surfaces can, by “over-defining” the problem, improve the positional estimate, e.g., by reducing sensitivity to measurement errors, to the effects of diffuse reflections, etc. In other embodiments, the direct and rebounded velocity and/or acceleration data may comprise directional information.

For example, directional information for direct ultrasound can identify that the object (or a specified portion of it) lies along a known ray, thereby providing two components of its velocity and/or acceleration. Information from rebounded ultrasound can then provide additional acceleration and/or velocity data sufficient to identify the third component of the object's velocity and/or acceleration, i.e., along the ray. The rebounded ultrasound may provide time-of-flight information; each object velocity and/or acceleration along the ray corresponds to a different time-of-flight for rebounded ultrasound from a surface, so the measured time-of-flight identifies the object's location, velocity, and/or acceleration. The rebounded ultrasound may provide directional information (for either transmission or reception); the intersection of this rebound ray with the direct ray serves to identify the object's location, velocity, and/or acceleration.

The enhanced velocity and/or acceleration data may be further enhanced or augmented using additional velocity and/or acceleration data obtained via direct or rebounded ultrasonic reflections and/or other velocity and/or acceleration data, such as velocity and/or acceleration data obtained via other means/systems/methods (e.g., laser detection, cameras, etc.). The direct and the rebounded velocity and/or acceleration data may provide velocity and/or acceleration data for the object at the same or different times, depending on the time at which they are reflected from the object. The enhanced positional data may be analyzed using a dynamical model, e.g., a Kalman filter, designed to combine velocity and/or acceleration data corresponding to different times or directional components, using them together with, and to improve, estimates of the object's present and/or future motion.

In some embodiments, direct ultrasonic reflections may not be used. Rather, a first rebounded ultrasonic reflection and a second rebounded ultrasonic reflection may be used to generate velocity and/or acceleration data. It is appreciated that any number of direct or rebounded ultrasonic reflections may be used to identify a position, velocity, acceleration, and/or other movement information of an object within a region. In various embodiments, the velocity and/or acceleration data gathered using ultrasonic reflections may be combined with other velocity and/or acceleration data, such as infrared, velocity and/or acceleration data provided by manual input, echo location, sonar techniques, laser, and/or the like.

In various embodiments, one or more local, remote, or distributed systems and/or system components may transmit ultrasound via an ultrasonic transmitter into a region. The received ultrasound may include both direct reflections and rebounded reflections. Velocity and/or acceleration data from both the direct reflections and the rebounded reflections may be used to obtain velocity and/or acceleration data that more accurately and/or more quickly describes the relative velocity and/or acceleration data of one or more objects within the region.

Embodiments may include various steps, which may be embodied in machine-executable instructions to be executed by a computer system. A computer system includes one or more general-purpose or special-purpose computers (or other electronic devices). The computer system may include hardware components that include specific logic for performing the steps or may include a combination of hardware, software, and/or firmware.

Embodiments may also be provided as a computer program product including a computer-readable medium having stored thereon instructions that may be used to program a computer system or other electronic device to perform the processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/computer-readable media suitable for storing electronic instructions.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even standalone machines which communicate with other machines by physical transport of media. In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

The network may include communications or networking software, such as the software available from Novell, Microsoft, Artisoft, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Each computer system includes at least a processor and a memory; computer systems may also include various input devices and/or output devices. The processor may include a general purpose device, such as an Intel®, AMD®, or other “off-the-shelf” microprocessor. The processor may include a special purpose processing device, such as an ASIC, an SoC, an SiP, an FPGA, an PAL, an PLA, an FPLA, an PLD, or other customized or programmable device. The memory may include static RAM, dynamic RAM, flash memory, one or more flip-flops, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, tape drive, optical drive, magneto-optical drive, or other means to read a storage medium. A suitable storage medium includes a magnetic, an optical, or other computer-readable storage device having a specific physical configuration. Suitable storage devices include floppy disks, hard disks, tape, CD-ROMs, DVDs, PROMs, RAM, flash memory, and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer executable code located within a memory device. A software module may, for instance, include one or more physical or logical blocks of computer instructions, which may be organized as a routine, program, object, component, data structure, etc., that performs one or more tasks or implements particular abstract data types.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used according to the present invention is already available, such as: general purpose computers, computer programming tools and techniques, computer networks and networking technologies, digital storage media, authentication, access control, and other security tools and techniques provided by public keys, encryption, firewalls, and/or other means.

The embodiments of the disclosure are described below with reference to the drawings, wherein like parts are designated by like numerals throughout. The components of the disclosed embodiments, as generally described and illustrated in the figures herein, could be arranged and designed in a wide variety of different configurations. Furthermore, the features, structures, and operations associated with one embodiment may be applicable to or combined with the features, structures, or operations described in conjunction with another embodiment. In other instances, well-known structures, materials, or operations are not shown or described in detail to avoid obscuring aspects of this disclosure.

Thus, the following detailed description of the embodiments of the systems and methods of the disclosure is not intended to limit the scope of the disclosure, as claimed, but is merely representative of possible embodiments. In addition, the steps of a method do not necessarily need to be executed in any specific order, or even sequentially, nor do the steps need to be executed only once.

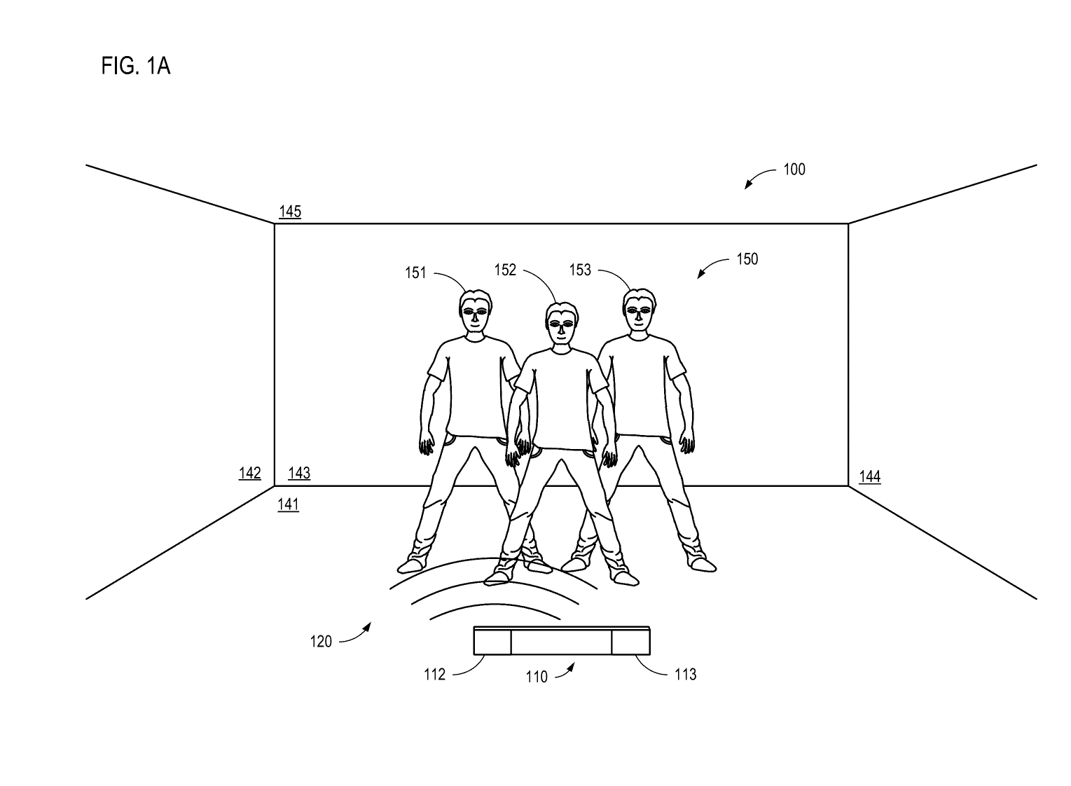

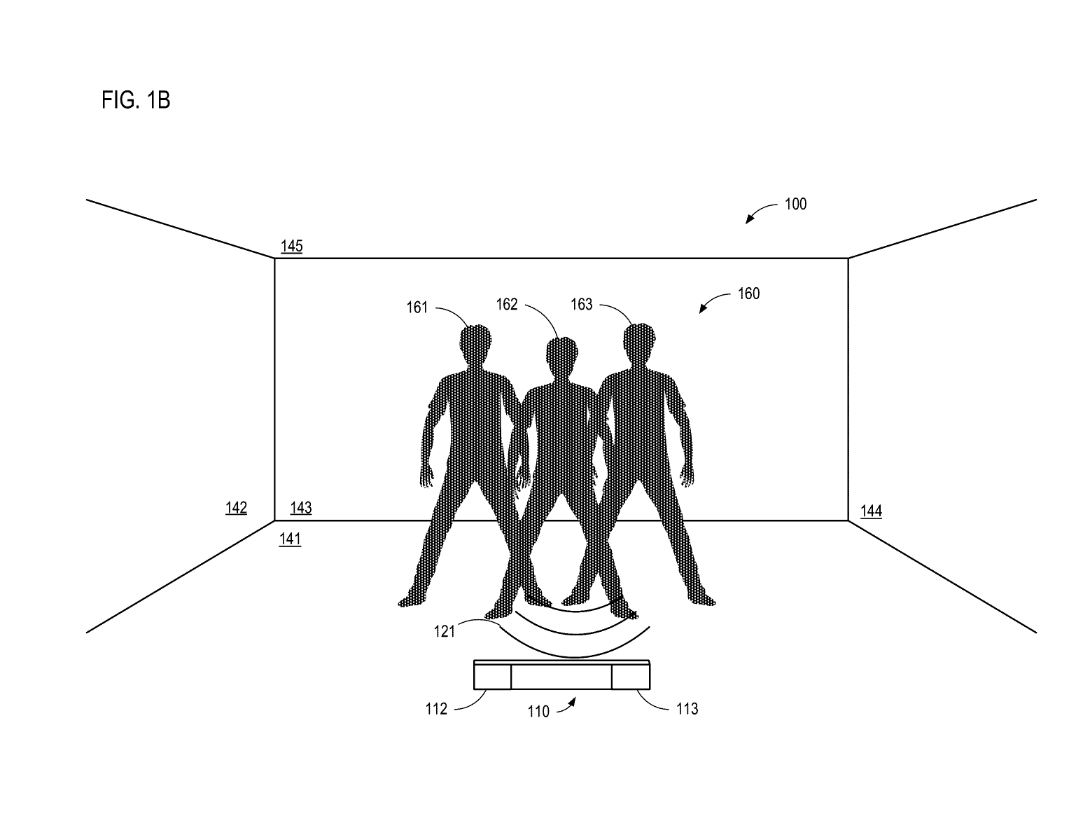

FIG. 1A illustrates a dual modality positioning system 110 transmitting ultrasound 120 toward three persons 151, 152, and 153 in a group 150 within a bounded region 100. As illustrated, the bounded region 100 is bounded by a floor 141, a left wall 142, a back wall 143, a right wall 144, and a ceiling 145. A front wall (not shown) may also bound the region 100.

The dual modality positioning system 110 may transmit the ultrasound 120 as directional ultrasonic pulses, continuously, in a modulated fashion (frequency, amplitude, phase, etc.), and/or in another format. The ultrasound 120 may be transmitted directly toward the persons 151, 152, and 153. The ultrasound 120 may be transmitted indirectly toward the persons 151, 152, and 153. The position of each of the persons may affect the state of an entertainment device used for providing induced tactile stimuli to the users.

In various embodiments, the dual modality positioning system 110 may be any shape or size and/or may comprise a plurality of distributed components. The illustrated embodiment is merely an example and is not intended to convey any information regarding shape, size, configuration, or functionality. In various embodiments, the dual modality positioning system 110 may include an array of transducers, such as piezoelectric transducers, configured to transmit and/or receive ultrasound and/or electromagnetic radiation. The dual modality positioning system 110 may be configured with a first plurality of transducers 112 (or a single transducer) for transmitting ultrasound and/or electromagnetic radiation and a second plurality of transducers 113 (or a single transducer) for receiving ultrasound.

FIG. 1B illustrates a direct ultrasonic reflection 121 received by the dual modality positioning system 110. As illustrated, the direct ultrasonic reflection 121 may convey coarse image information in a relatively two-dimensional fashion in which the three persons 151, 152, and 153 are viewed as a single object 160, or as three distinct objects (161, 162, and 163) in substantially the same plane. The image data may be generated directly or from a plurality of lower resolution images using compressed sensing. FIG. 1B illustrates a visual representation of the received direct ultrasonic reflection 121. The actual positional data received may be at a higher or lower resolution depending on the sampling rates, accuracy, processing bit depth, frequency(ies) of ultrasound used, etc.

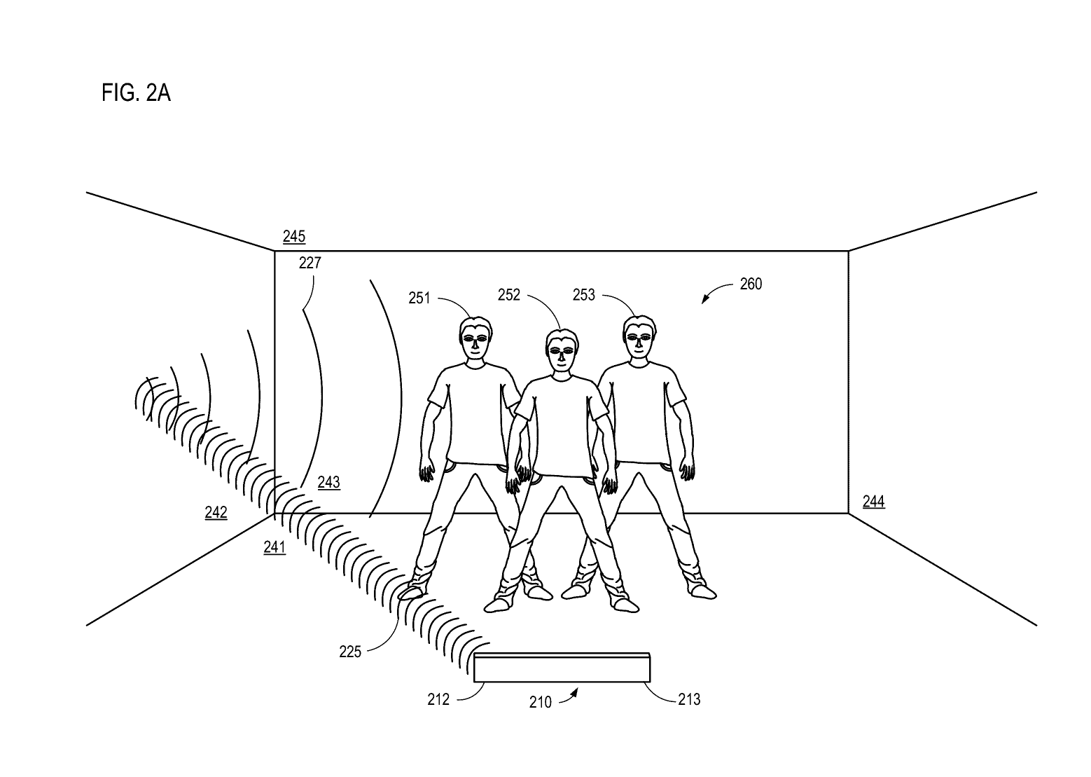

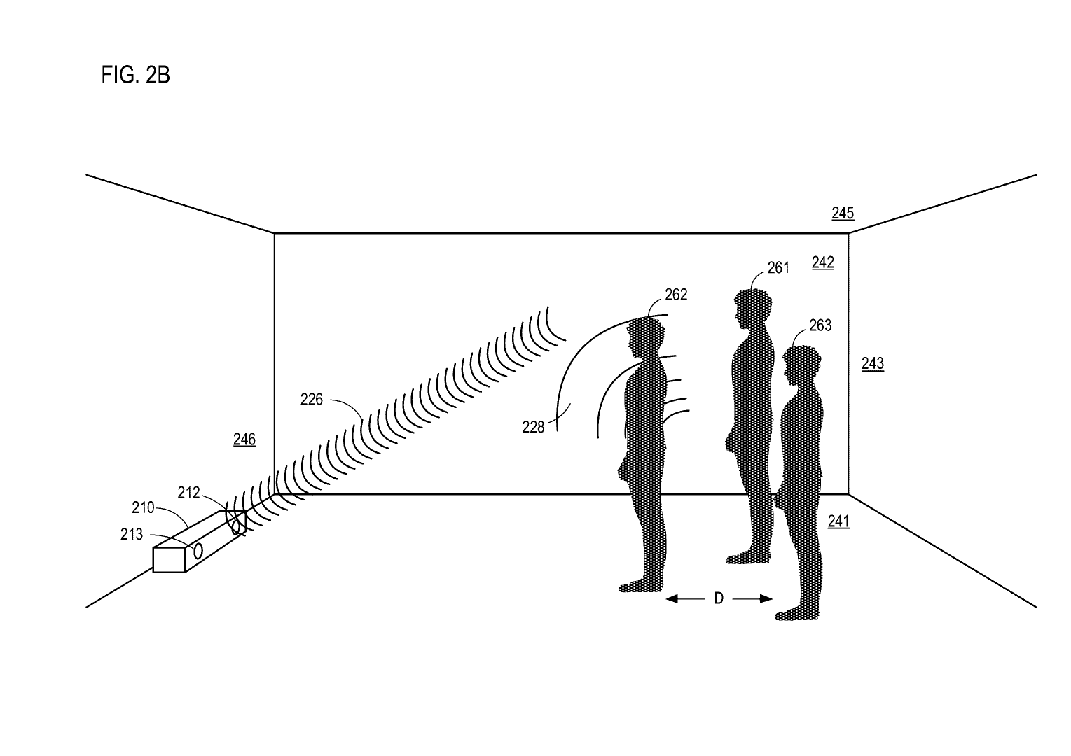

FIG. 2A illustrates a dual modality positioning system 210, similar to that described in conjunction with FIGS. 1A and 1B, in which ultrasound 225 is transmitted toward a surface bounding the region. In the illustrated embodiment, the rebounding surface is left wall 242. It is appreciated that ultrasound may be rebounded off one or more of left wall 242, floor 241, back wall 243, right wall 244, and/or ceiling 245. Similarly, electromagnetic radiation may be rebounded off one or more of left wall 242, floor 241, back wall 243, right wall 244, and/or ceiling 245. In some embodiments, the system may receive electromagnetic radiation from other sources (e.g., ambient light in the region).

As used herein, the terms rebound and rebounding may include any type of reflection, refraction, and/or repeating that may or may not include a phase, frequency, modulation, and/or amplitude change. Rebounding may be performed by the outer surface of the surface, an inner portion of the surface, or an object disposed on, in, or behind the surface (e.g., exterior paint, drywall, internal metal, studs, interior coatings, mounted panels, etc.).

The ultrasound may ultimately be rebounded 227 to reflect off persons 251, 252, and 253 at a different angle than that obtained in FIGS. 1A and 1B. The illustrated embodiment shows the rebounded ultrasound 227 reflecting off the left wall 242 prior to the persons 251-253. However, the ultrasound may reflect off persons 251-253 prior to the left wall 242 instead. Ultimately, ultrasound 225 may be rebounded and/or reflected by persons 251-253 and one or more of surfaces/walls 241-245 in any order and then be received by the dual modality positioning system 210.

FIG. 2B illustrates a side view of the dual modality positioning system 210 described in conjunction with FIG. 2A with the rebounded ultrasound 226 being received after reflecting off persons 251-253, at location 228, and rebounding off left wall 242. FIG. 2B also shows a front wall 246. In some embodiments, all of the ultrasound may be transmitted against a front wall 246 to more evenly distribute ultrasound throughout the region (i.e., a wider effective beam width).

As illustrated in FIG. 2B, the positional data obtained by the rebounded ultrasound 226 may provide coarse image information not available via the direct reflections shown in FIGS. 1A and 1B, e.g., due to one object preventing direct ultrasound from reaching a second object (or another portion of the first object). For instance, the visual representation of the positional data obtained illustrates three distinct objects 261, 262, and 263 that are clearly in distinct planes relative to the dual modality positioning system 210. For instance, the positional data generated based on the rebounded ultrasound 226 in FIG. 2B shows a distance D between object 262 and objects 261 and 263. Such a distance D may be difficult to determine or determined differently if only direct reflections were available (as in FIGS. 1A and 1B).

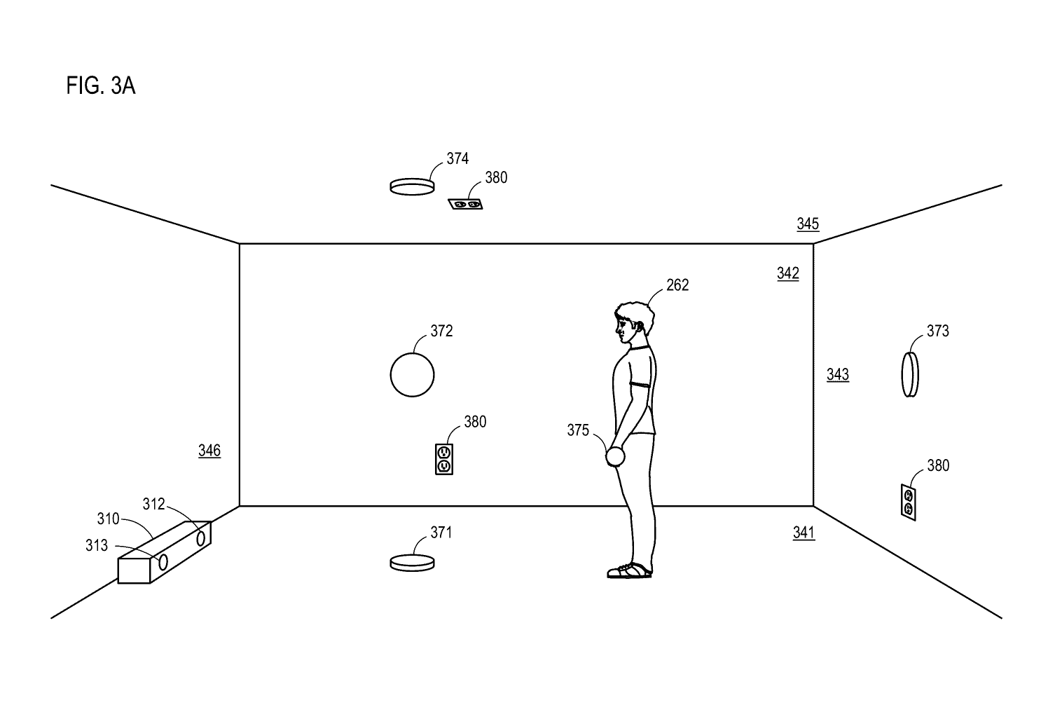

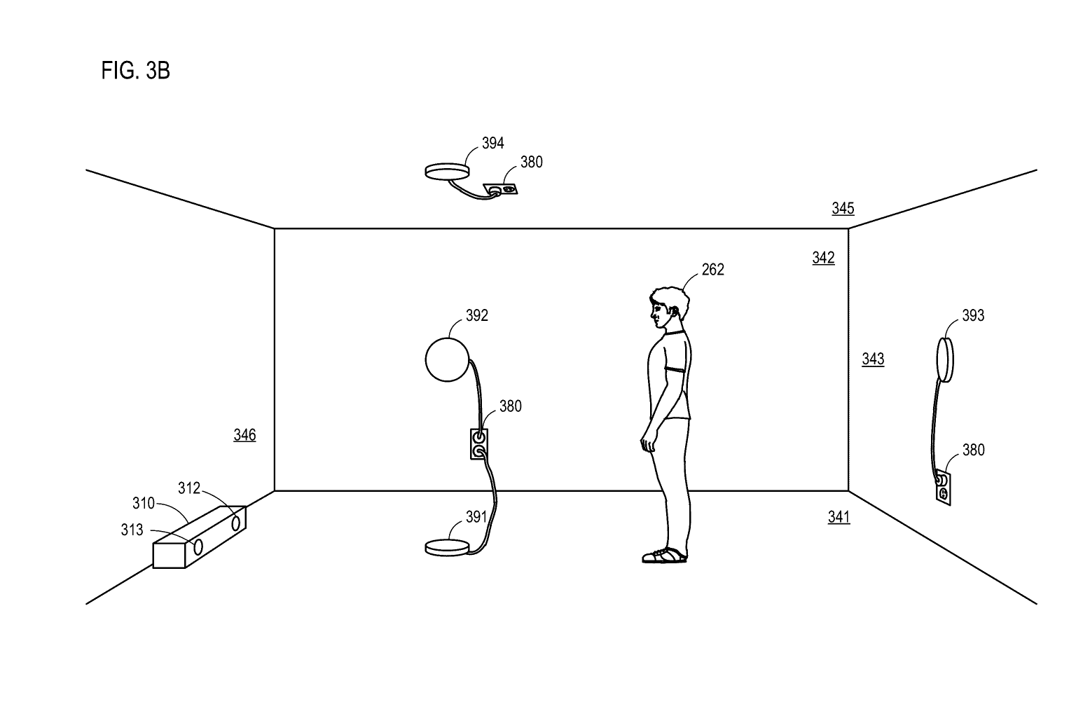

FIG. 3A illustrates a plurality of ultrasonic and/or electromagnetic radiation reflectors 371, 372, 373, and 374 secured to, mounted to, positioned within, and/or integrally formed with one or more of the surfaces 341, 342, 343, 345, and 346. In some embodiments, a user/subject may hold or otherwise control a portable ultrasonic and/or electromagnetic radiation reflector 375. The ultrasonic reflectors 371-375 may facilitate the transmission, reflection, and/or reception of rebounded ultrasound by the dual modality positioning system 310.

The ultrasonic and/or electromagnetic radiation reflectors may comprise passive, active, and/or actively moved/pivoted ultrasonic reflectors for controlling the direction in which ultrasound rebounds and/or otherwise travels within the region. For example, the ultrasonic and/or electromagnetic radiation reflector may be configured to modify one or more of the frequency, phase, and/or amplitude of the rebounded ultrasound and/or electromagnetic radiation. The modified characteristic may facilitate the differentiation of the direct ultrasonic and/or electromagnetic radiation reflections and the rebounded ultrasonic and/or electromagnetic radiation reflections.

The dual modality positing system 310 may generate positional data associated with one or more of the object(s) based on the direct ultrasonic and/or electromagnetic radiation reflection(s) (e.g., FIGS. 1A and 1B) and/or the rebounded ultrasonic and/or electromagnetic radiation reflection(s) (e.g., FIGS. 2A and 2B). The positional data may comprise a centroid of the objects, a two-dimensional mapping of the object, an image of the object, a false-color representation of the object, an information representation (blocks, squares, shadows, etc.) of the object, a three-dimensional mapping of the object, one or more features of the object, and/or other information. The positional data generated via one modality (i.e., the ultrasonic or the electromagnetic radiation) may be at a higher or lower resolution that the positional data generated by the other modality. In addition, the positional data in either or both modalities may be enhanced or generated using compressed sensing techniques.

The positional data may be defined with respect to one or more surfaces of the region, the dual modality positioning system 310, a receiver 312 of the positioning system 310, and/or a transmitter 313 of the positioning system 310. The one or more objects within the region may comprise machinery, robots, furniture, household property, people in general, gamers, human controllers of electronic devices, electronic devices, fixtures, and/or other human or non-human objects.

The object may comprise a specific portion or site of a person, such as a hand, finger, arm, leg, foot, toe, torso, neck, head, mouth, lip, and/or eye. As illustrated in FIGS. 3A and 3B, rebounded ultrasonic transmissions may be reflected off an ultrasonic reflector 391-394 disposed within the room. In some embodiments, the ultrasonic reflectors may modify a characteristic of the reflected ultrasound, facilitating the identification of the received rounded ultrasonic reflections.

FIG. 3B illustrates a plurality of active ultrasonic reflectors 391-394 configured to facilitate the transmission, reflection, and/or reception of rebounded ultrasound by the positioning system. As illustrated, active ultrasonic reflectors 391-394 may be connected to a power source, such as batteries, solar cells, heat converts, outlets 380, and/or other suitable power source. In some embodiments, the ultrasound itself may provide the power source.

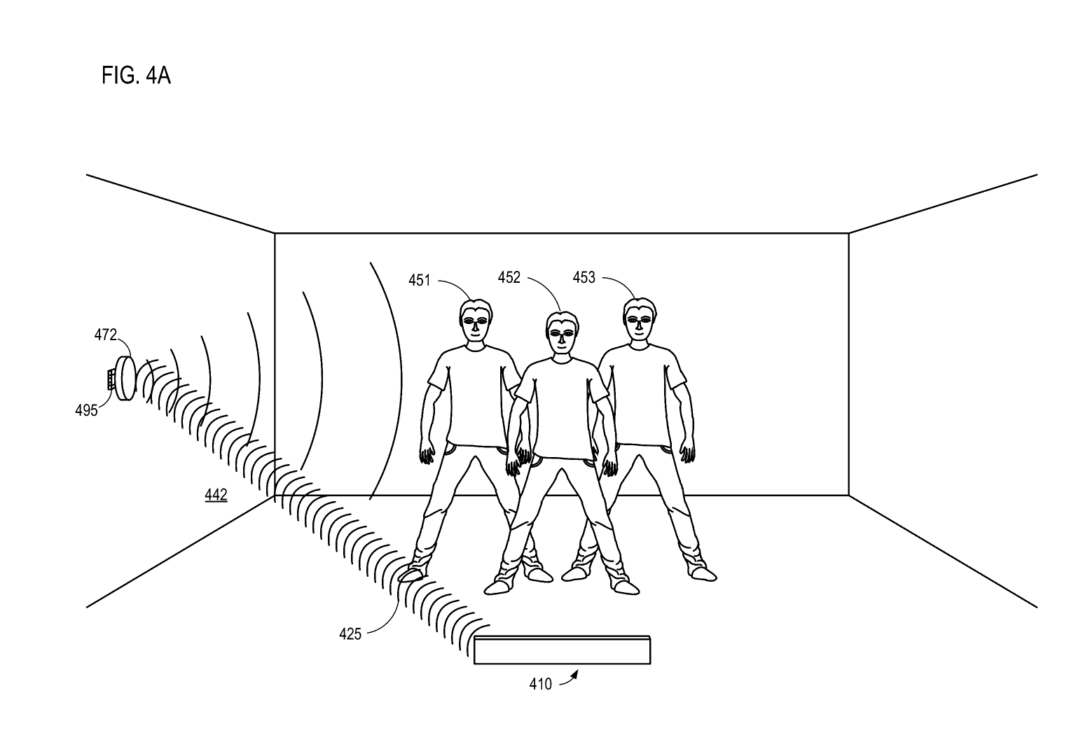

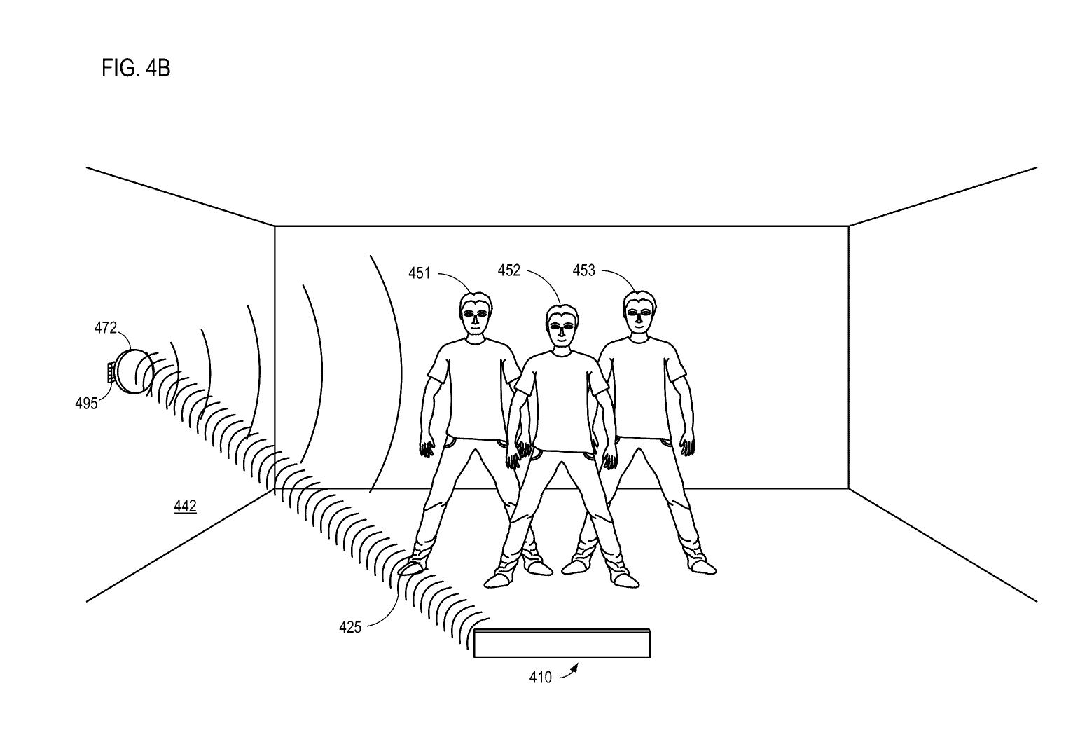

FIG. 4A illustrates an actively controlled ultrasonic reflector 472 in a first position. A dual modality positioning system 410 may be in communication with the ultrasonic reflector 472, or the ultrasonic reflector 472 may be autonomous. In various embodiments, the dual modality positioning system 410 may transmit ultrasound 425 toward the persons 451, 452, and 453 or toward the left wall 442, as illustrated. The ultrasound 425 may then be rebounded off the left wall 442 or reflected by the persons 451-453, respectively.

FIG. 4B illustrates the actively controlled ultrasonic reflector 472 in a second position. The ultrasonic reflector 472 may be pivoted and/or controlled by a pivot control 495.

In some embodiments, pivot control 495 may change other reflective, absorptive, and/or refractive properties of the ultrasonic reflector 472, in addition to its direction. For example, the ultrasonic reflector 472 may have specific ultrasonic or other acoustic absorptive properties. A pivot control 495 may adjust the pivoting and/or acoustic and/or electrical properties.

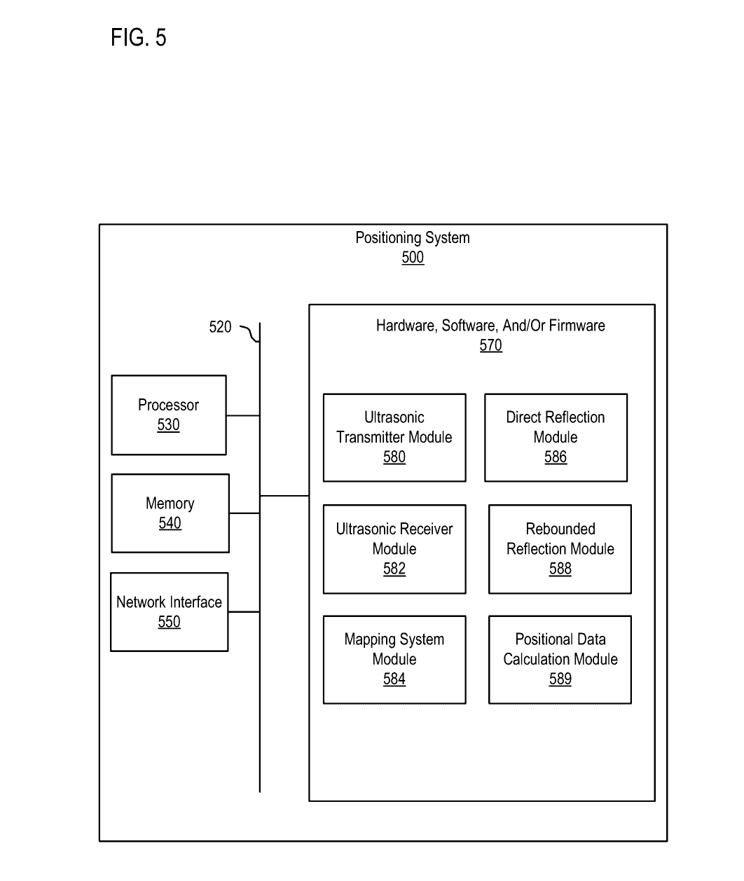

FIG. 5 illustrates a block diagram of a positioning system 500, according to one embodiment. As illustrated, a positioning system 500 may include a processor 530, a memory 540, and possibly a network 550 or other data transfer interface. A bus 520 may interconnect various integrated and/or discrete components. Various modules may be implemented in hardware, software, firmware, and/or a combination thereof.

An ultrasonic transmitter module 580 may be configured to transmit ultrasound in any of the various forms and/or methods described herein. An ultrasonic receiver module 582 may be configured to receive a direct ultrasonic reflection from an object within a region. Additionally, the ultrasonic receiver module 582 may be configured to receive rebounded ultrasonic reflection from the object. As used herein, direct reflections and rebounded reflections refer to the various descriptions provided herein as well as the generally understood and variations of these terms.

A mapping system module 584 generates direct positional data associated with the object based on one or more direct ultrasonic reflections. The mapping system module 584 may also generate direct positional data associated with the object based on one or more indirect ultrasonic reflections, as may be understood in the art. The mapping system module 584 may also generate rebounded positional data associated with the object based on one or more indirect ultrasonic reflections, as may be understood in the art.

A direct reflection module 586 may be configured to facilitate, manage, and/or monitor the transmission and/or reception of direct reflections. The rebounded reflection module 588 may be configured to facilitate, manage, and/or monitor the transmission and/or reception of rebounded reflections.

The positional data calculation module 589 may generate direct positional data associated with the object based on one or more direct ultrasonic reflections. The positional data calculation module 589 may also generate rebounded positional data associated with the object based on one or more rebounded ultrasonic reflections. The positional data calculation module 589 may also generate enhanced positional data by combining the direct positional data and the rebounded positional data.

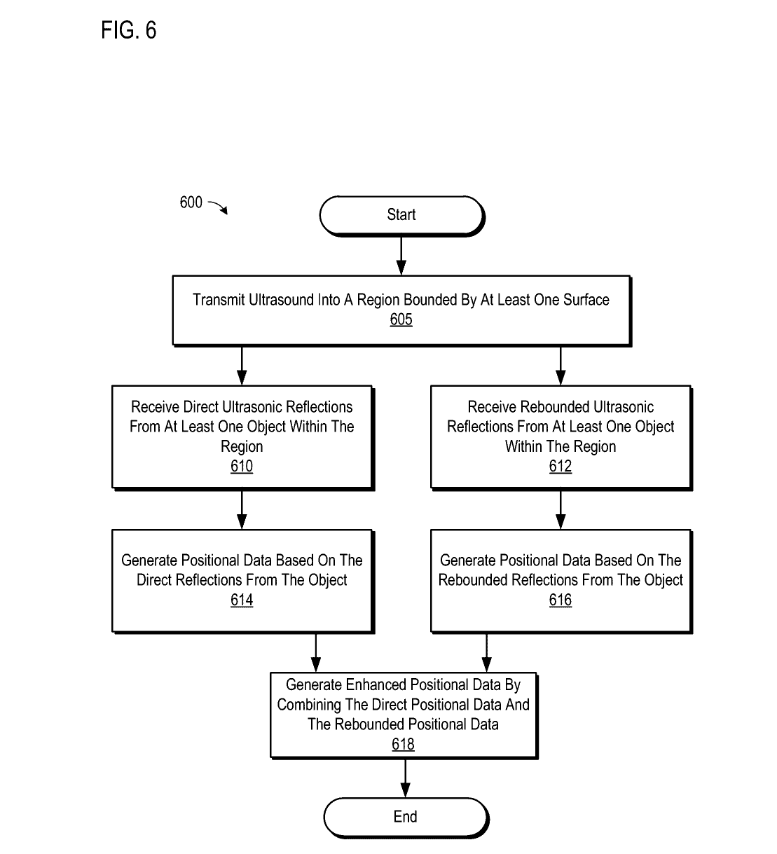

FIG. 6 illustrates a flow chart of a method 600 for generating positional data describing a relative position and/or movement of one or more objects within a region. The method steps are provided in no particular order and may be rearranged as would be technically feasible. A positioning system may transmit 605 ultrasound into a region bounded by at least one surface. The positioning system may receive 610 direct ultrasonic reflections from at least one object within the region.

The positioning system may receive 612 rebounded ultrasonic reflections from at least one object within the region. The rebounded ultrasonic reflections may reflect off the wall(s) first and/or off the object(s) first. The positioning system may generate 614 positional data based on the direct reflections from the object. The positioning system may generate 616 positional data based on the rebounded reflections from the object.

The positioning system may generate 618 enhanced positional data by combining the direct positional data and the rebounded positional data. In other embodiments, the positioning system may transmit the direct positional data and the rebounded positional data to another electronic or other processing device for usage.

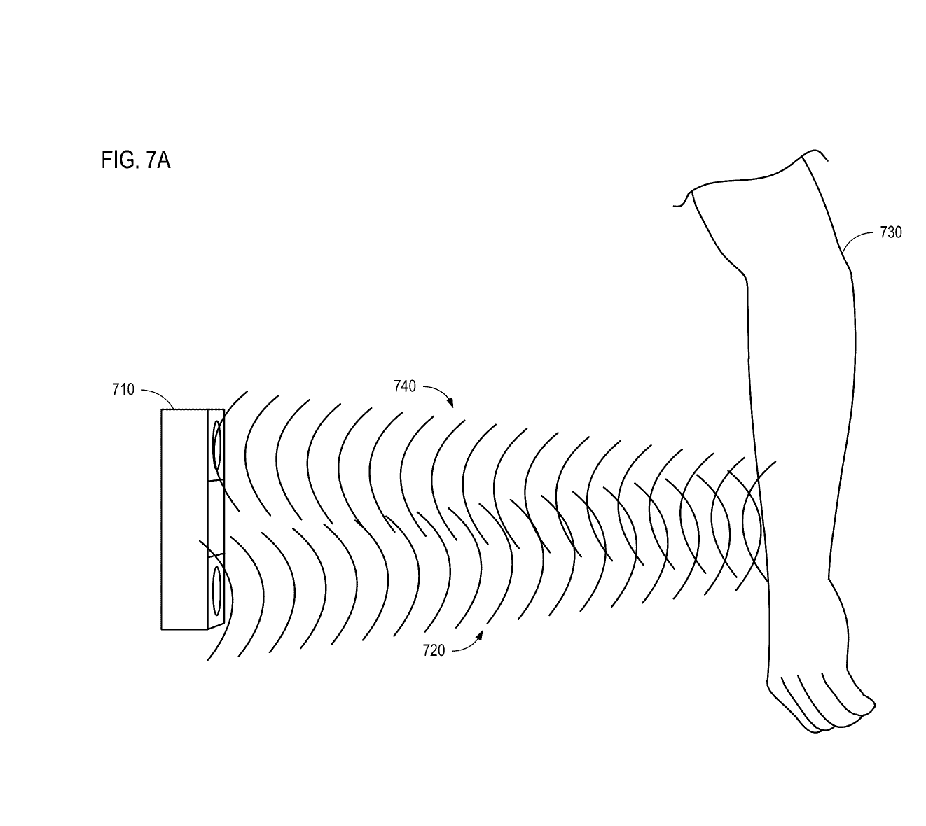

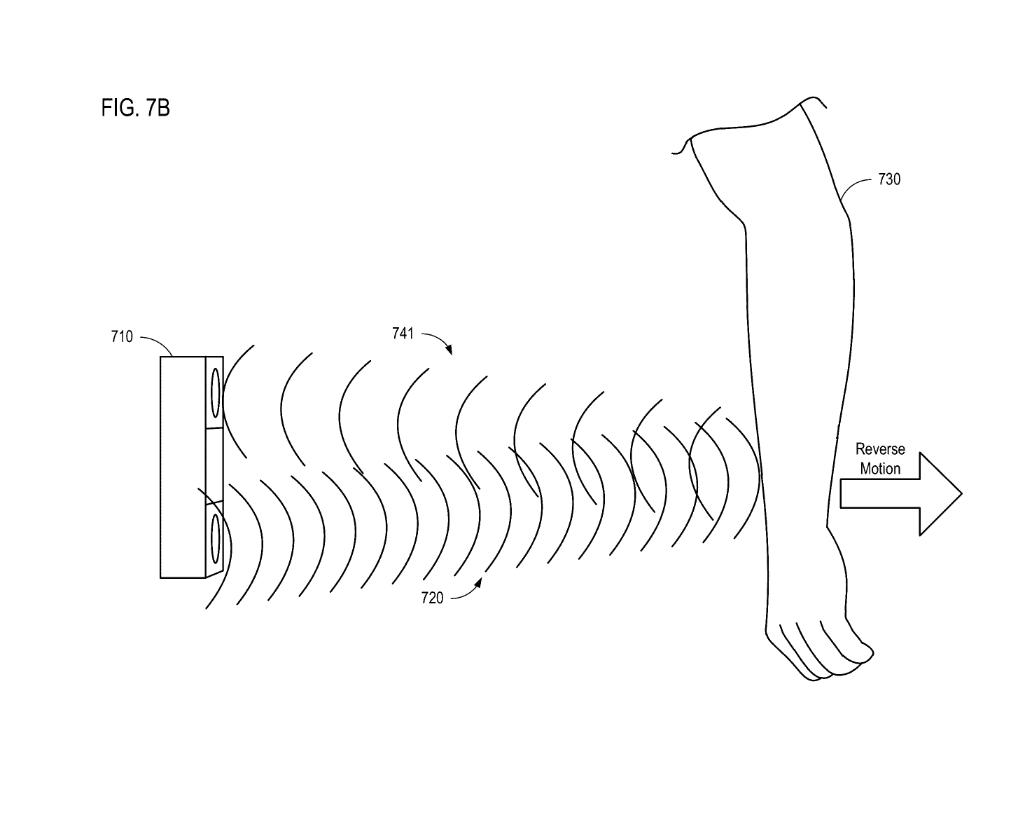

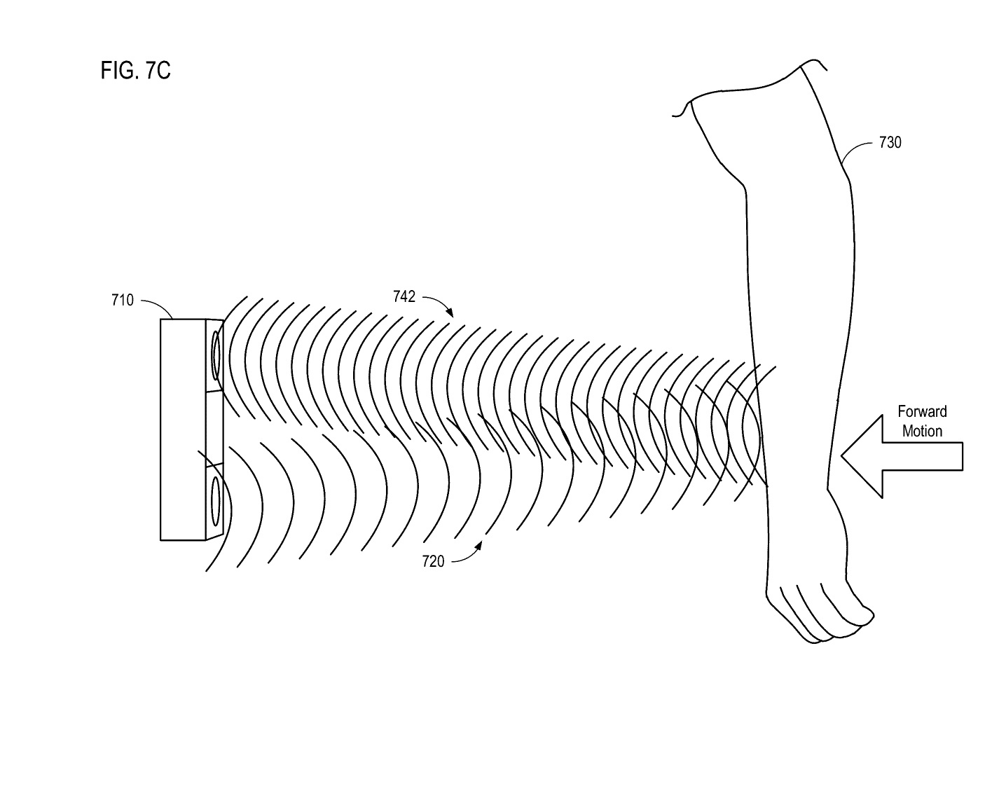

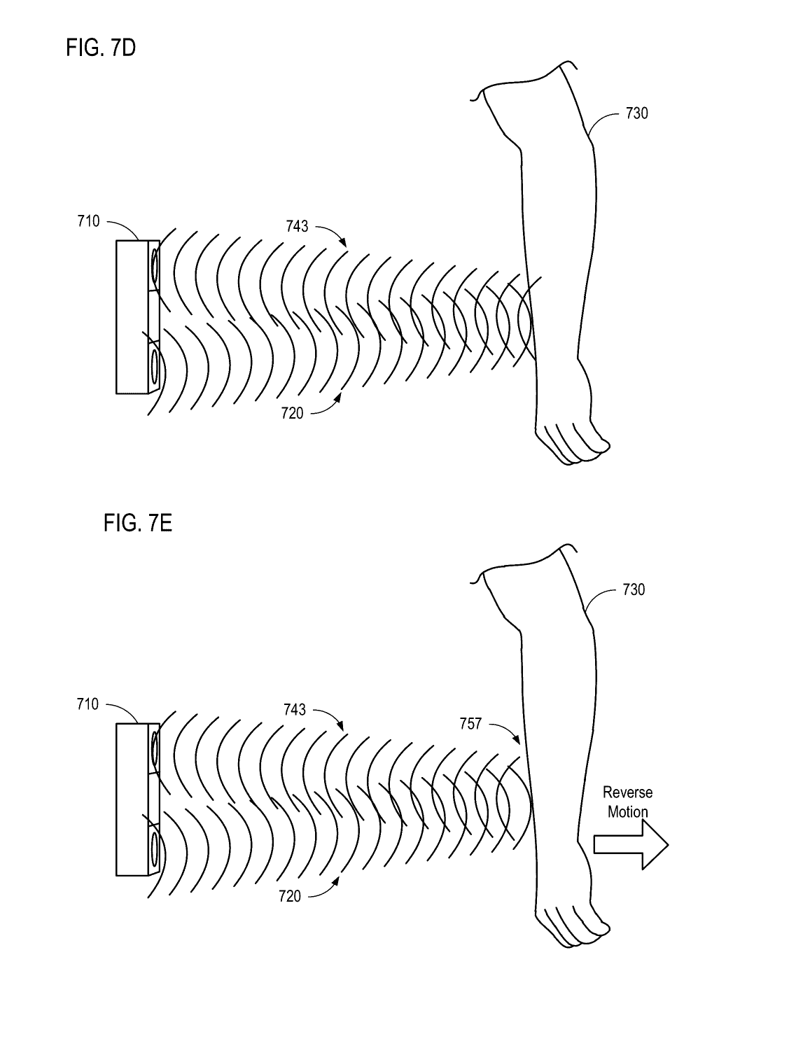

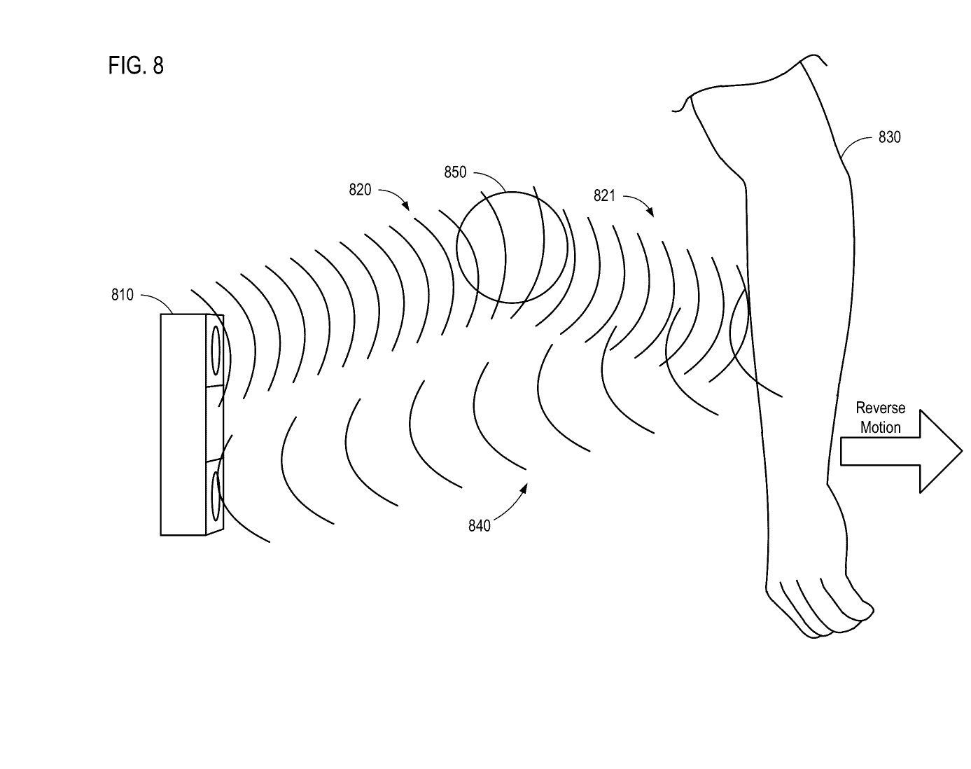

Any of the various configurations of ultrasonic transmitters, receivers, reflectors, and/or other components described in conjunction with the detection of the position of an object may also be applied to the embodiments described herein with respect to the detection and/or calculation of velocity and/or acceleration data associated with an object or objects, including those embodiments described below with reference to FIGS. 7A-12. For example, direct and rebounded reflections, multiple reflectors, and/or ultrasonic paths may be used to calculate velocity and/or acceleration data associated with an object within a region.

FIG. 7A illustrates an ultrasonic system 710, which can be used as part of a dual modality positioning system, transmitting 720 and receiving 740 reflected ultrasound from a stationary object 730. The spacing between the arcs representing the ultrasound 720 and 740 is representative of the wavelength and/or frequency of the ultrasound. With the object 730 in a stationary position, the reflected ultrasound 740 is not shifted with respect to the transmitted ultrasound 720.

FIG. 7B illustrates the ultrasonic system 710 transmitting ultrasound 720 at a first frequency and receiving reflected ultrasound 741 at a second frequency from an object moving away from the ultrasound system 710. The frequency shift can be detected and used to determine the velocity of the reverse motion of the object 730. For example, the velocity of the object 730, Vₒ, is equal to the change in frequency, Δf, multiplied by the velocity of the ultrasound, Vᵤₛ, divided by the frequency of the transmitted ultrasound, fₜᵣₐₙₛ, relative to the ultrasonic receiver. Any of a wide variety of Doppler shift velocity and/or acceleration calculation and/or estimation algorithms may be utilized.

FIG. 7C illustrates an ultrasound system 710 transmitting ultrasound 720 at a first frequency and receiving reflected ultrasound 742 at a second frequency from an object 730 moving toward the ultrasound system 710. Again, any of a wide variety of Doppler shift algorithms for calculating, determining, and/or estimating the relative velocity of the object 730 with respect to the ultrasound system 710 may be used. For example, the Doppler equation:

$${f}_{r} = ( \frac{C + {V}_{r}}{C + {V}_{o}} ) {f}_{t} \qquad Equation 1$$

In equation 1 above it is assumed that a transmission medium (e.g., air) is relatively stationary, fᵣ is the frequency of the received ultrasound, C is the velocity of the ultrasound in the medium (e.g., air), Vᵣ is the velocity of the ultrasonic receiver relative to the medium, Vₒ is the velocity of the object relative to the medium, and fₜ is the frequency of the transmitted ultrasound. An acceleration of the object may be determined using velocity calculations at multiple discrete time periods and/or by detecting a change in the frequency of the received ultrasound, fᵣ, over time.

As described herein, the ultrasonic system 710 may include one or more ultrasonic transmitters and/or ultrasonic receivers and the transmitters and receivers may be physically joined (as illustrated in FIG. 7C) or they may be separated and even possible positioned in disparate locations within the region. In some embodiments, the transmitters and receivers may be embodied in a single transducer. In other embodiments, each transducer may act as both an ultrasonic transmitter and an ultrasonic receiver. In yet other embodiments each transducer may be used in conjunction with an electromagnetic position detection system and/or receiver system as a dual modality positioning system.

FIG. 7D illustrates an ultrasonic system 710 transmitting and receiving reflected ultrasound 720 and 743 from a stationary object 730, similar to FIG. 7A. FIG. 7D provides a representative context for FIG. 7E.

FIG. 7E illustrates a timing delay and/or phase shift, illustrated as missing wave arc 757, in reflected ultrasound 743 from the object 730 as it moves away from the ultrasound system 710. As provided herein Doppler shifts may be used to determine acceleration and/or velocity information associated with a moving object. It is, however, recognized that various methods of velocity measurement may be utilized including, for example, phase shift (i.e., when received signals arrive) measurements, similar to those used in Doppler echocardiography. It is appreciated that various 1 D, 2D, and 3D vector Doppler calculations of velocity and/or acceleration information of an object may be incorporated into the presently described systems and methods, including, but not limited to, 2D Doppler Imaging, Vector Doppler, Speckle Tracking, and others.

FIG. 8 illustrates ultrasound 820 rebounded, at 821, off of a reflector 850 (e.g., an auxiliary reflector) prior to being reflected by an object 830 moving away from an ultrasonic receiver 810. A shift in the received ultrasound 840 relative to the transmitted ultrasound 820 can be used to determine a velocity of the object 830 relative to the ultrasonic receiver 810.

In one embodiment, the ultrasound may first be reflected by the object 830, and then rebounded by the reflector 850. In such an embodiment, it may be possible to determine velocity and/or acceleration information of the object 830 relative to the reflector 850.

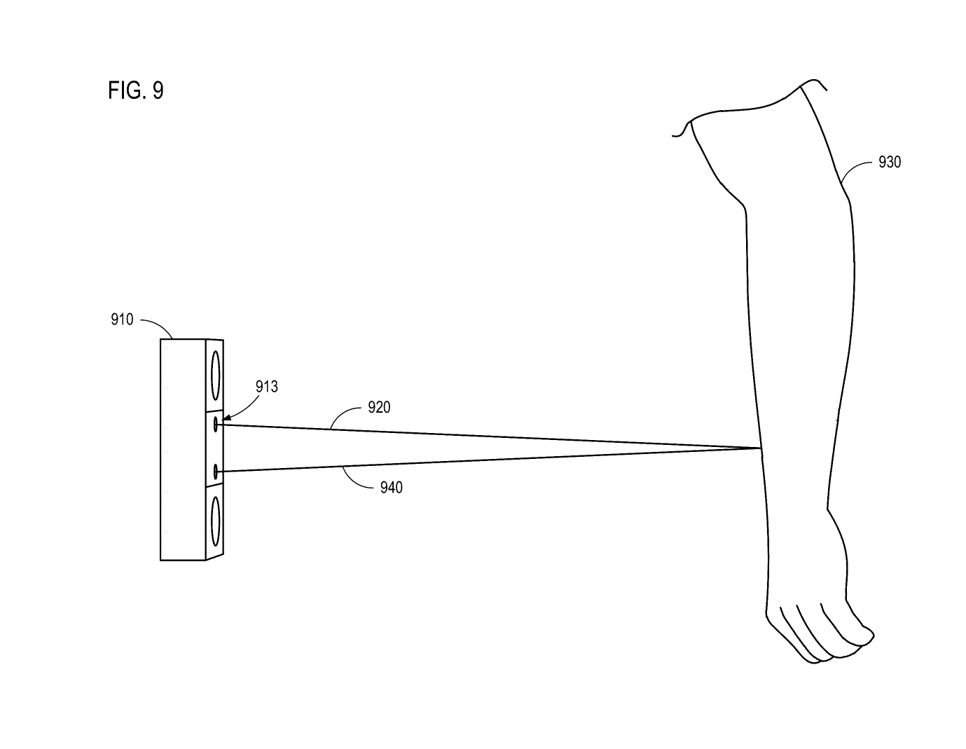

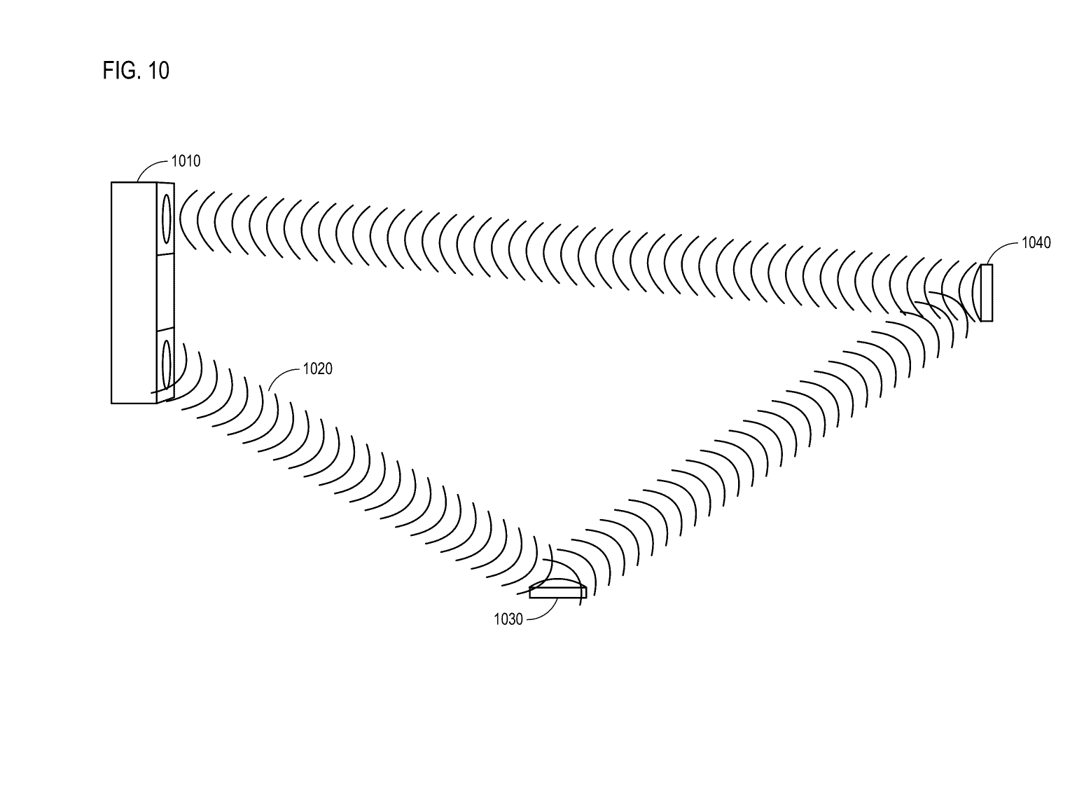

FIG. 9 Illustrates an electromagnetic position detection system 913 used in conjunction with an ultrasound velocity and/or acceleration detection system 910 as a dual modality positioning system. The ultrasonic velocity and/or acceleration detection system 910 may operate and/or be configured in conjunction with any of the various embodiments described herein for determining position, velocity, and/or acceleration information at a current time and/or for estimating such information at a future time. The electromagnetic position detection system 913 may detect a position of the object 930 using time-of-flight. For example, a laser or other electromagnetic radiation source may be used to measure a time-of-flight between the electromagnetic position detection system 913 and the object 930. The position information obtained via an electromagnetic position detection system 913 may be used in conjunction with velocity and/or acceleration data obtained using the ultrasonic system 910 described herein.

FIG. 10 illustrates ultrasound 1020 reflected and/or rebounded from one or more auxiliary reflectors 1030 and 1040. As described in various embodiments, an ultrasonic receiver/transmitter 1010 may utilize direct reflections from an object within a region to determine velocity and/or acceleration information based on a detected frequency shift and/or phase shift. In some embodiments, rebounded ultrasonic reflections may be utilized in addition to or instead of direct ultrasonic reflections. Ultrasonic reflectors 1030 and 1040 may be active or passive and may be integrated into one or more appliances, walls, or other features of the region. In some embodiments, existing walls, room features, furniture, people, objects, or the like may be identified and/or specified as reflectors 1030 and 1040.

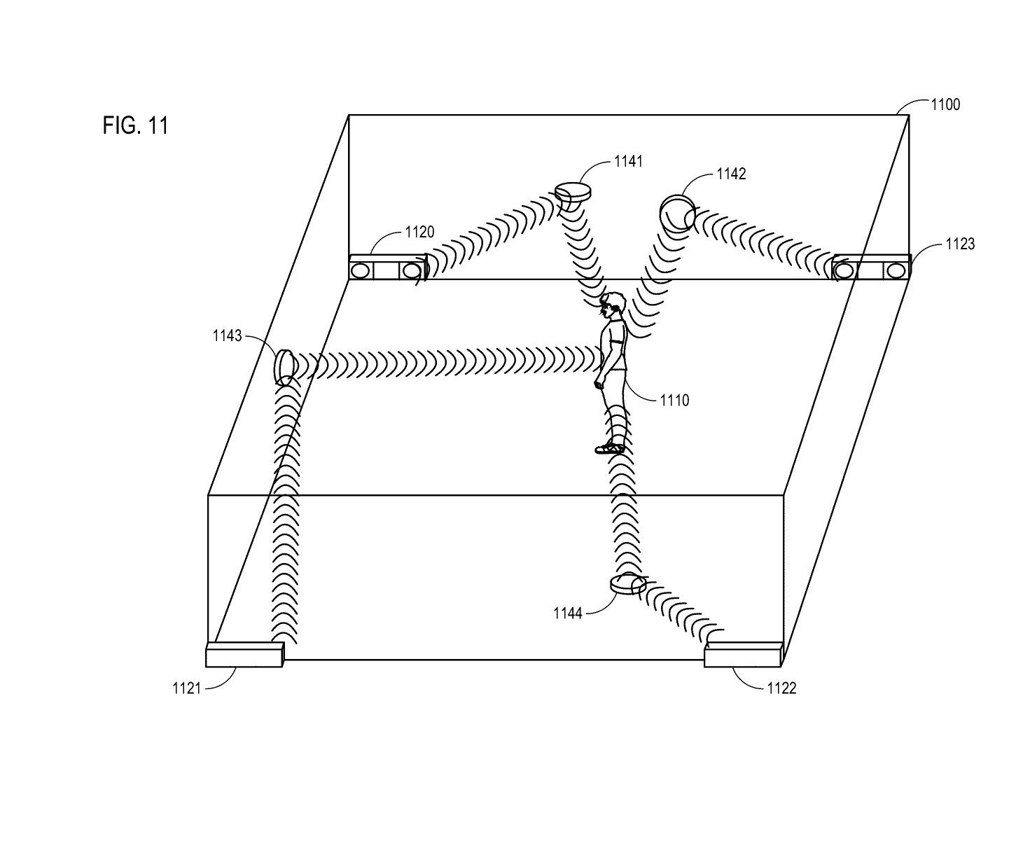

FIG. 11 illustrates a plurality of ultrasonic systems 1120, 1121, 1122, and 1123 for determining velocity and/or acceleration information from multiple directions relative to the object 1110 or a site on object 1110 within a region 1100. In various embodiments, each ultrasonic system 1120-1123 may include one or more ultrasonic transmitters and one or more ultrasonic receivers. In other embodiments, one or more of the ultrasonic systems 1120-1123 may include one or more ultrasonic transmitters or one or more ultrasonic receivers. In some embodiments, the ultrasonic transmitters and ultrasonic receivers may be separate components spaced apart from one another. As illustrated, the ultrasound may be rebounded off of one or more auxiliary reflectors 1141, 1142, 1143, and 1144.

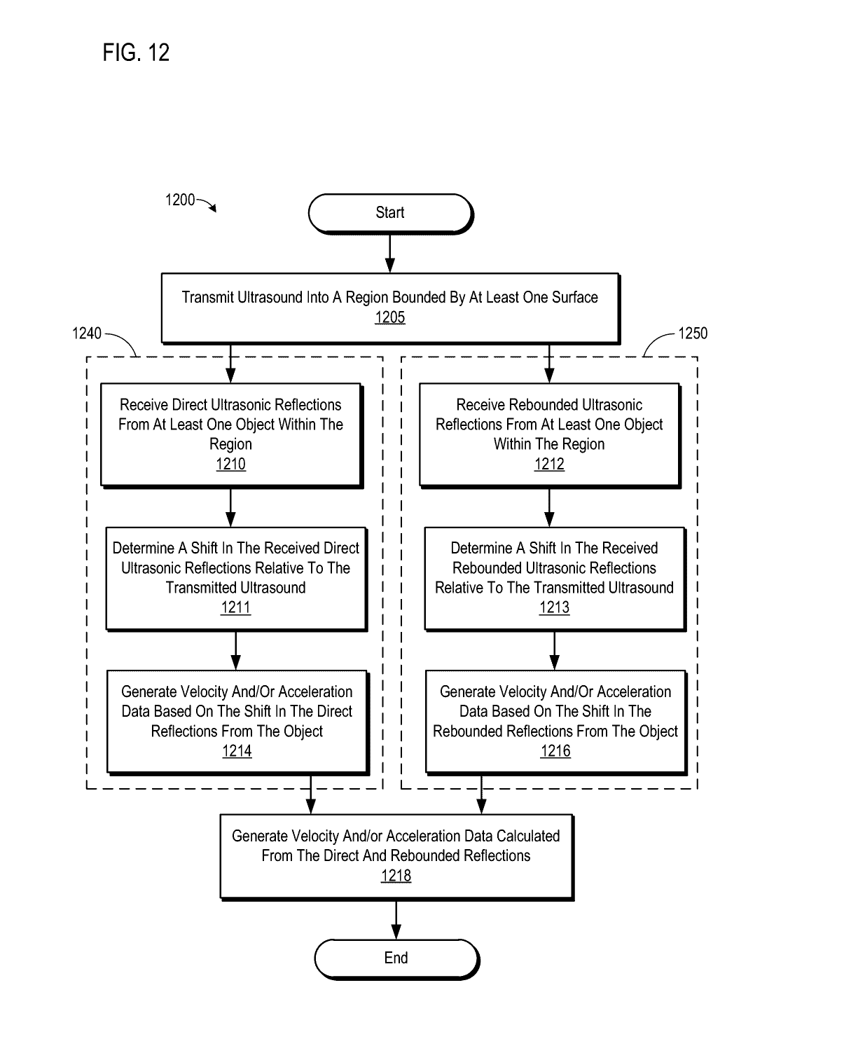

FIG. 12 illustrates a method 1200 for determining velocity and/or acceleration information associated with a moving object. Ultrasound may be transmitted 1205 into a region bounded by at least one surface. Some embodiments may utilize direct reflections from the object to determine velocity and/or acceleration data based on a detected shift in the ultrasound, as provided in block 1240. A receiver may receive 1210 direct ultrasonic reflections from at least one object or a site on an object within the region. A shift, such as a wavelength shift, frequency shift, or phase shift, may be determined 1211 between the transmitted ultrasound and the received ultrasound. The system may then generate 1214 velocity and/or acceleration data based on the detected shift.

It is understood that “determining a shift,” “detecting a shift,” “calculating a shift,” and the like may not necessarily require an actual determination of the difference between the, e.g., frequency, of the transmitted and received ultrasound. That is, “detecting a shift” and similar phrases may be constructively performed during a Doppler calculation of velocity and/or acceleration. For example, “detecting a shift” may be constructively performed if a velocity of an object is determined using (1) a known/measured frequency of transmitted ultrasound and (2) a known/measured frequency of ultrasound reflected by the object. The system may or may not actually calculate the frequency difference between the transmitted and received ultrasound, as various derivative and equal algorithms for Doppler-based velocity calculations may be utilized.

In some embodiments, rebounded reflections from the object may be used to determine velocity and/or acceleration data based on a detected shift in the ultrasound, as provided in block 1250. Ultrasound may be transmitted 1205 into a region bounded by at least one surface. A receiver may receive 1212 rebounded ultrasonic reflections from at least one object or a site on an object within the region. A shift, such as a wavelength shift, frequency shift, or phase shift, may be determined 1213 between the transmitted ultrasound and the received ultrasound. The system may then generate 1216 velocity and/or acceleration data based on the detected shift. In various embodiments, velocity and/or acceleration data from direct reflections and rebounded reflections may be optionally combined 1218. Velocity and/or acceleration data from direct reflections and rebounded reflections may be used to determine two-dimensional vectors of velocity and/or acceleration information related to the object or a site on the object.

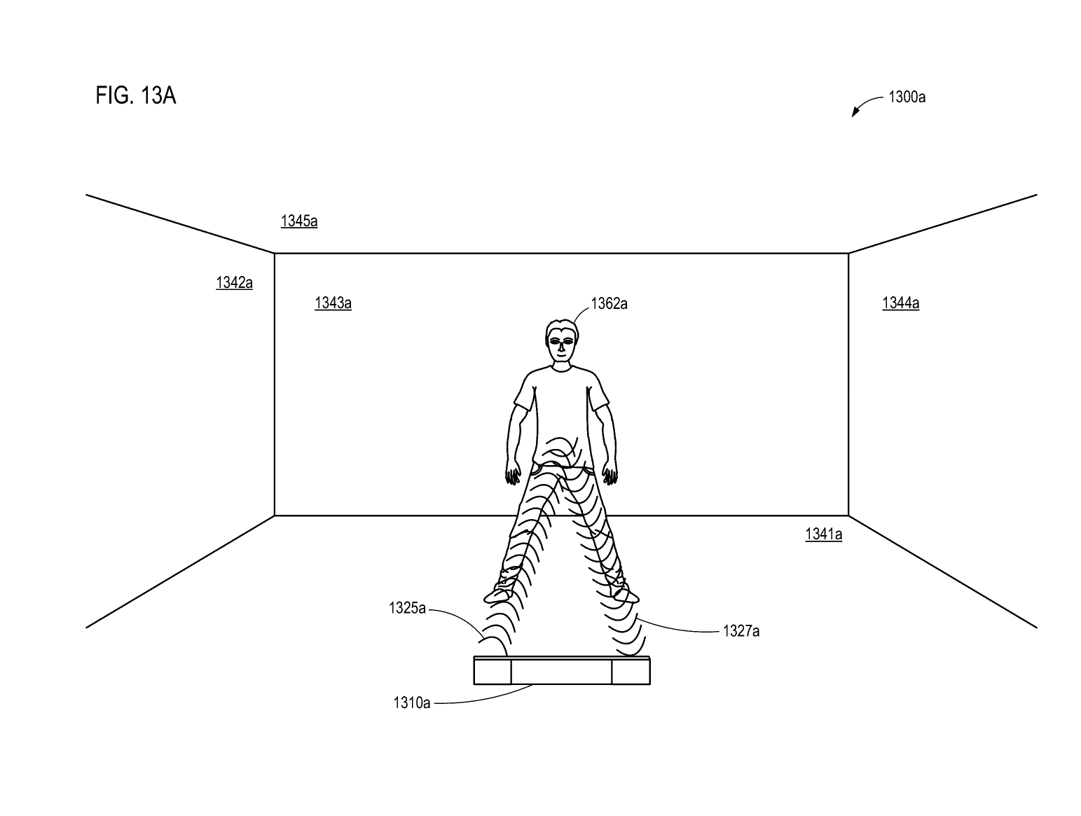

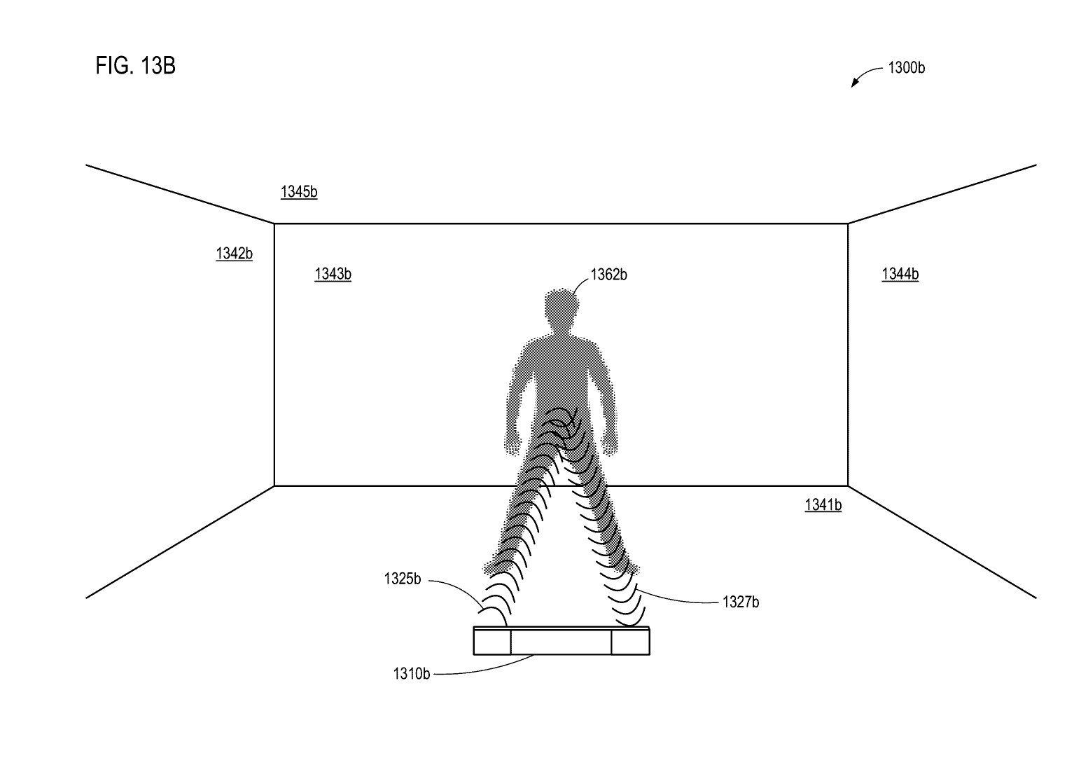

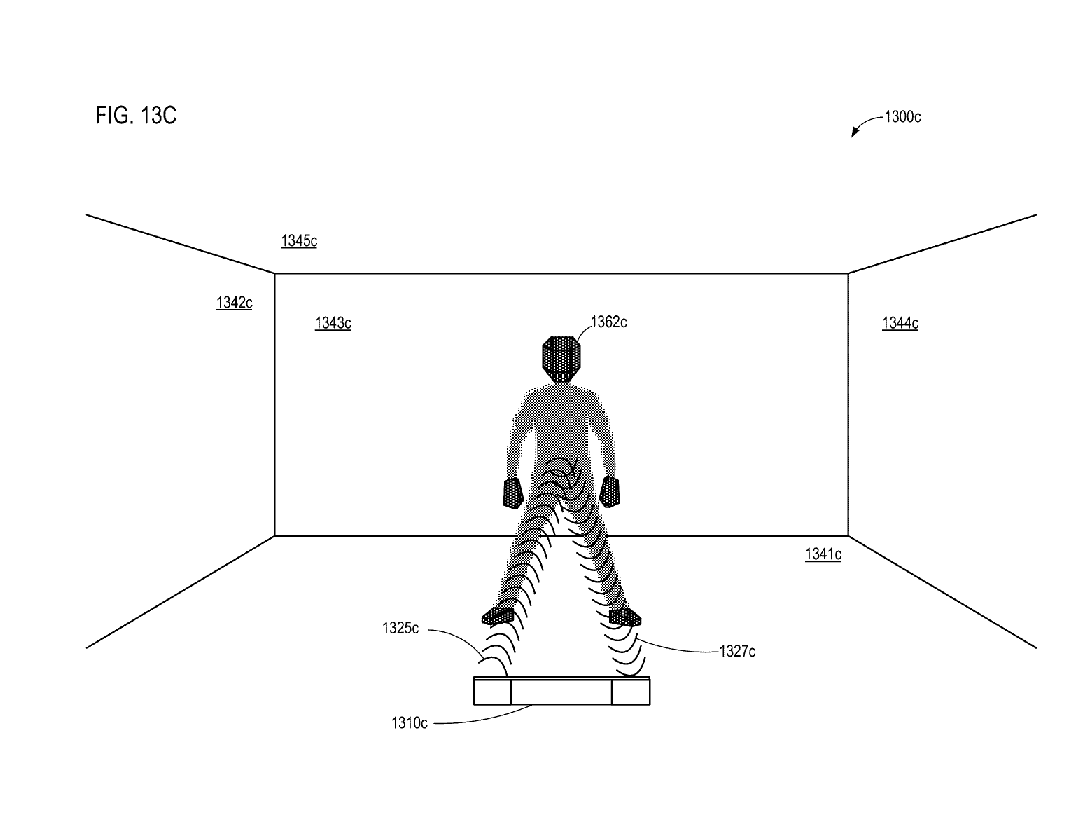

FIG. 13A illustrates a dual modality positioning system 1310a transmitting ultrasound 1325a and receiving ultrasound 1327a reflected off a person 1362a standing within a bounded region 1300a. As illustrated, the bounded region 1300a is bounded by a floor 1341a, a left wall 1342a, a back wall 1343a, a right wall 1344a, and a ceiling 1345a. A front wall (not shown), may also bound the region 1300a.

The dual modality positioning system 1310a may utilize its ultrasound modality similar to that discussed in relation to the previous figures. For example, the dual modality positioning system 1310a may transmit the ultrasound 1325a as directional ultrasonic pulses, continuously, in a modulated fashion (frequency, amplitude, phase, etc.), and/or in another format. The ultrasound 1325a may be transmitted directly toward the person 1362a and/or the ultrasound 1325a may be transmitted indirectly toward the person 1362a.

FIG. 13B illustrates a dual modality positioning system 1310b generating coarse image data of an object based on received ultrasonic reflections. As illustrated, the direct ultrasonic reflection 1327b may convey coarse image information in a relatively two-dimensional fashion. The dual modality positioning system 1310b may use a processor to generate coarse image data of a person 1362b or other object. The actual image data received may be at a higher or lower resolution depending on the sampling rates, accuracy, processing bit depth, frequency(ies) of ultrasound used, etc. In certain examples, to use less processing power, the dual modality positioning system 1310b may use a low resolution to track the object as a whole. The coarse image may also be generated from a plurality of lower resolution image captures using compressed sensing. If a low resolution is used, portions of interest may be identified for which more detailed information is desirable, useful, and/or necessary for a particular application.

FIG. 13C illustrates a dual modality positioning system 1310c identifying several portions of interest on an object using coarse image data generated directly from ultrasonic reflections 1327c (or alternatively using received electromagnetic radiation) or using compressed sensing. Portions of interest on a person 1362c may include a hand, finger, arm, leg, foot, toe, torso, neck, head, mouth, lip, and eye. For example, as illustrated in FIG. 13C the dual modality positioning system 1310c has identified the hands, feet, and head as portions of interest on person 1362c.

The portion of interest may be identified based partly on the state of an associated entertainment device. For example, a state of the associated entertainment device may utilize a hand movement for a particular action that cannot be determined using coarse image data. In that situation, the dual modality positioning system 1310c may identify the hands of a person 1362c as a portion of interest for which fine image data (i.e., higher resolution images) are desired. Whatever portions of interest are identified, the dual modality positioning system 1310c may use a second modality to receive additional and more detailed image information.

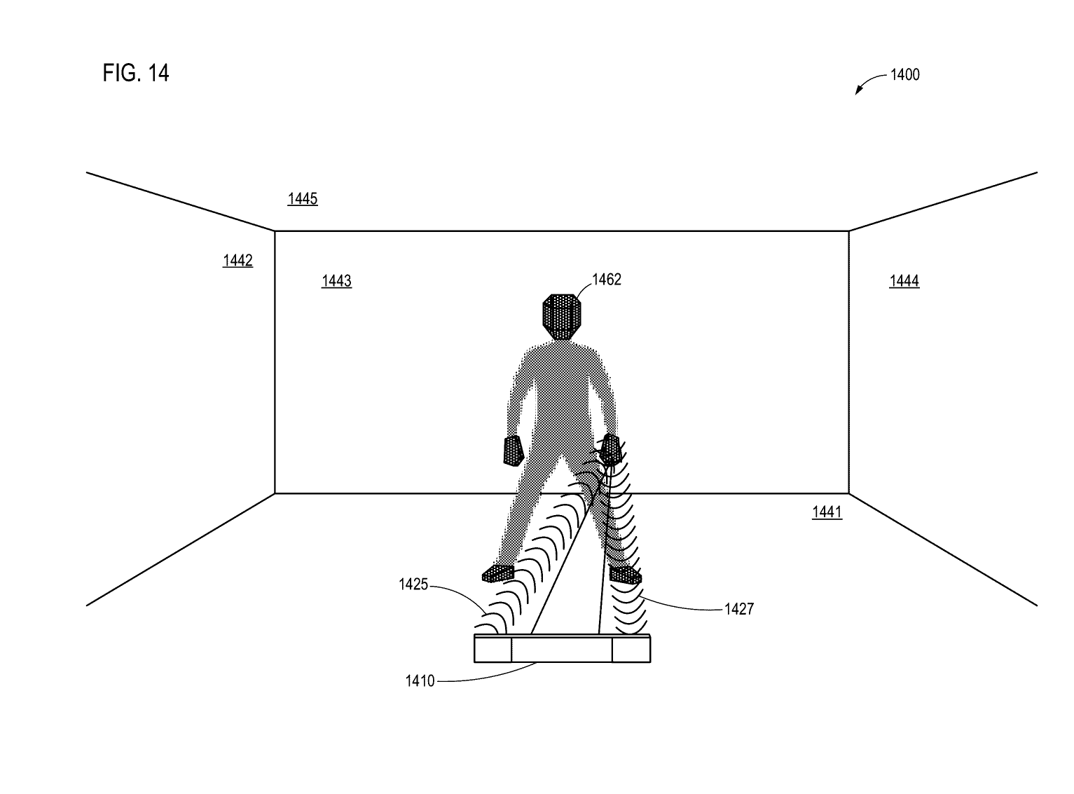

For example, FIG. 14 illustrates a dual modality positioning system 1410 using electromagnetic imaging in conjunction with ultrasound 1425 to receive additional image information from identified portions of interests. In addition to ultrasound, the dual modality positioning system 1410 may use electromagnetic transmitters and/or receivers to receive/determine electromagnetic image information. For example, a laser or other electromagnetic radiation source may be used to receive image data of an object. In certain examples, the dual modality positioning system 1410 may use a receiver such as an infrared receiver to gather image data from ambient radiation sources. In certain examples, electromagnetic radiation received may include microwave, terahertz, infrared, visible, and/or ultraviolet radiation.

A system may use electromagnetic imaging capabilities to receive either coarse image data at a low-resolution or fine image data at a higher, more detailed resolution. For example, FIG. 14 illustrates a dual modality positioning system 1410 receiving electromagnetic radiation from an identified portion of interest on a two-dimensional coarse image generated using received ultrasonic reflections 1427. The electromagnetic radiation received may be used to generate a higher resolution image than the image generated using the received ultrasonic reflections 1427. In certain examples the fine or coarse image data may be generated or enhance using compressed sensing.

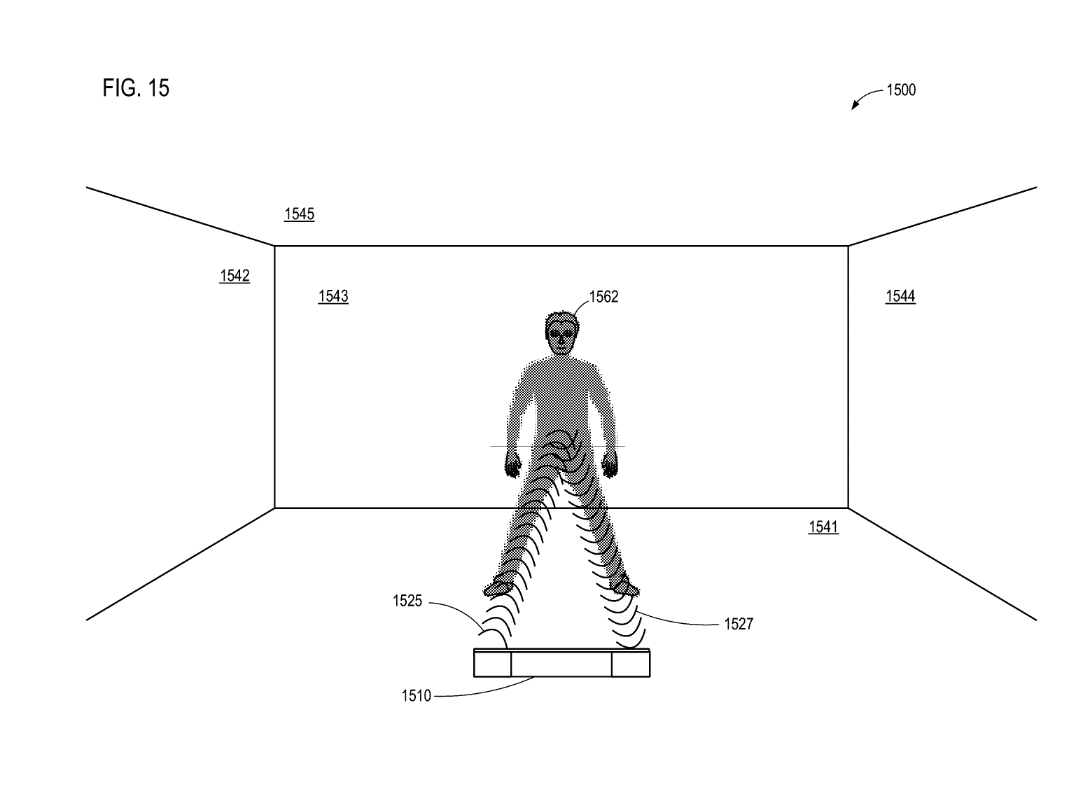

For example, FIG. 15 illustrates a dual modality positioning system 1510 generating fine image data of portions of interest on a person 1562. One modality, such as ultrasound 1525, may be used to generate a coarse image with a low resolution while a second modality, such as electromagnetic radiation, may be used to generate a detailed image with a higher resolution. It will be understood that either ultrasound or electromagnetic radiation may be utilized to gather the low-resolution image or the higher resolution image. In addition the image data in either modality (e.g., ultrasound or electromagnetic radiation) may be generated directly or using compressed sensing.

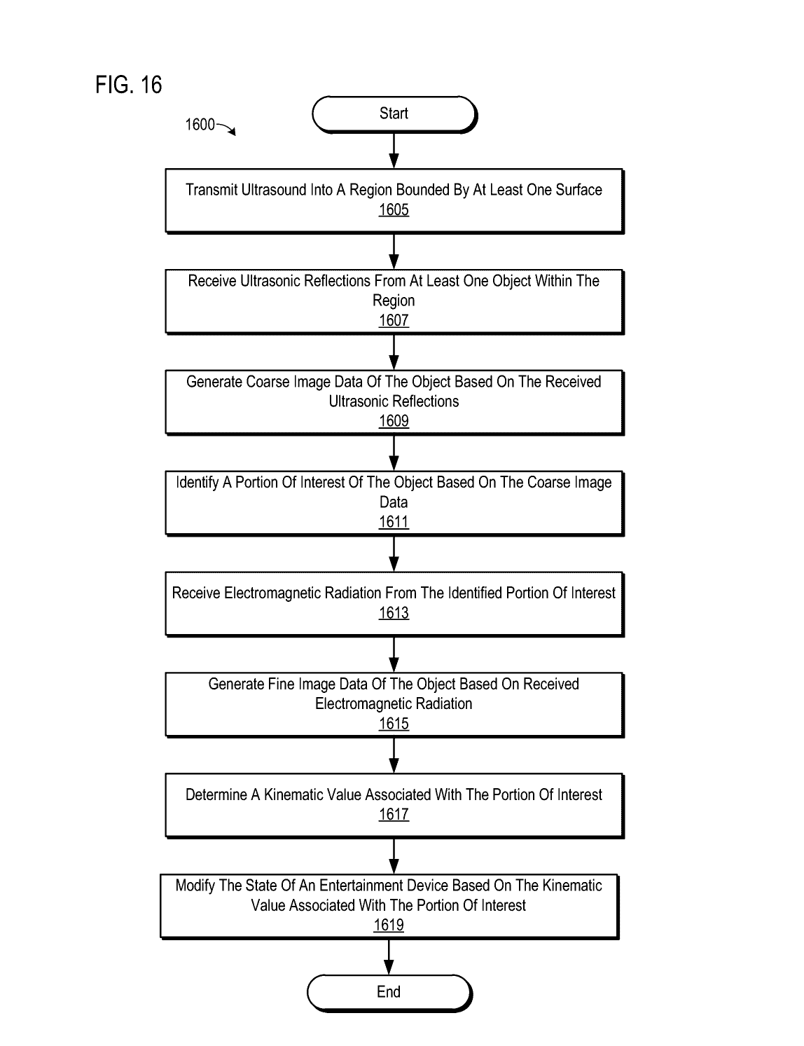

FIG. 16 illustrates a method for generating an image using ultrasound and electromagnetic radiation. The method steps are provided in no particular order and may be rearranged as would be technically feasible. A dual modality positioning system may transmit 1605 ultrasound into a region bounded by at least one surface. The dual modality positioning system may receive 1607 direct or rebounded ultrasonic reflections from at least one object within the region. Using the received ultrasonic reflection, the dual modality positioning system may generate 1609 coarse image data of the object. The coarse image may be generated from a plurality of lower resolution image captures using compressed sensing. The dual modality positioning system may identify 1611 one or more portions of interest on an object. The dual modality positioning system may receive 1613 electromagnetic radiation from the portion(s) of interest, and using the electromagnetic radiation, generate 1615 fine image data of the object. The fine image data may be of a higher resolution than the coarse image data. Optionally, the system may also determine 1617 a kinematic value associated with the portion of interest, and modify 1619 the state of an entertainment device based on the kinematic value.

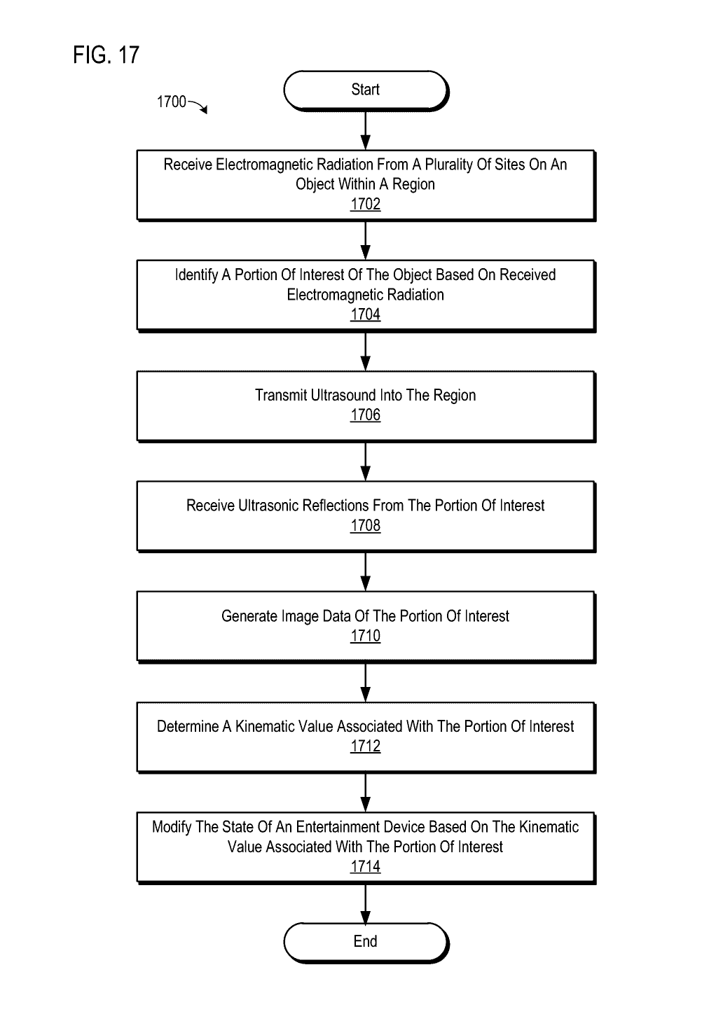

FIG. 17 illustrates a method for generating an image using ultrasound and electromagnetic radiation. The method steps are provided in no particular order and may be rearranged as would be technically feasible. The dual modality positioning system may receive 1702 electromagnetic radiation from a plurality of sites within a region. In some embodiments, the received electromagnetic radiation may use compressed sensing to generate a coarse image of an object or site on an object with the region. The dual modality positioning system may identify 1704 one or more portions of interest on an object. The dual modality positioning system may transmit 1706 ultrasound into the region, and receive 1708 direct or rebounded ultrasonic reflections from the portion of interest. From the received ultrasonic reflection, the dual modality positioning system may generate 1710 fine (higher resolution) image data of the object and/or portions of interest on the object. Optionally, the system may also determine 1712 a kinematic value associated with the portion of interest, and modify 1714 the state of an entertainment device based on the kinematic value.

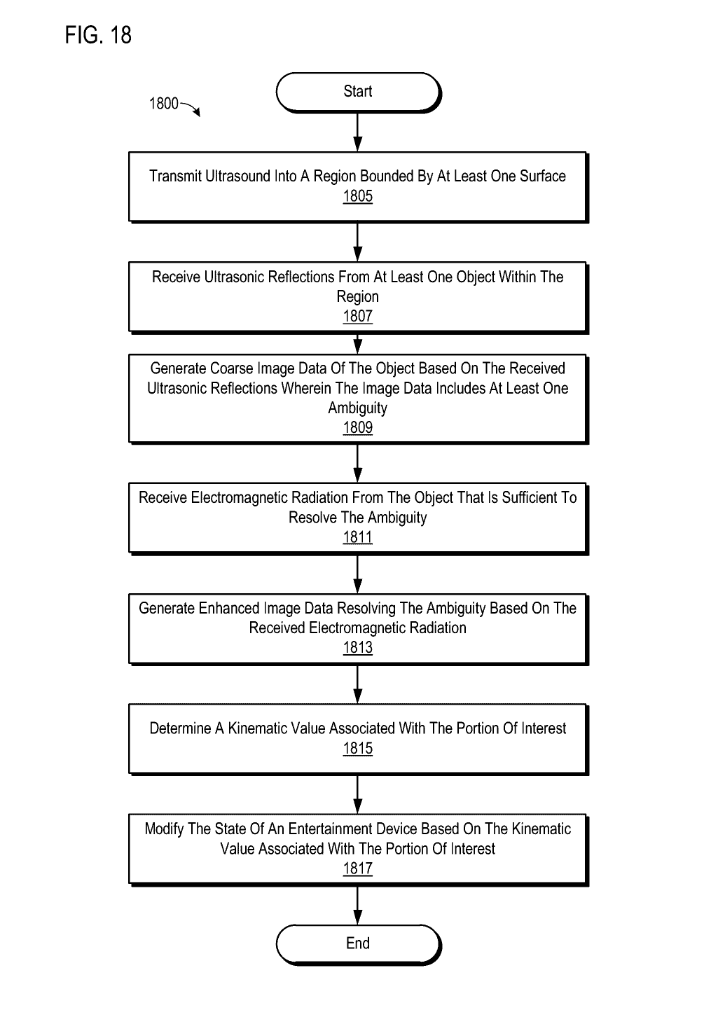

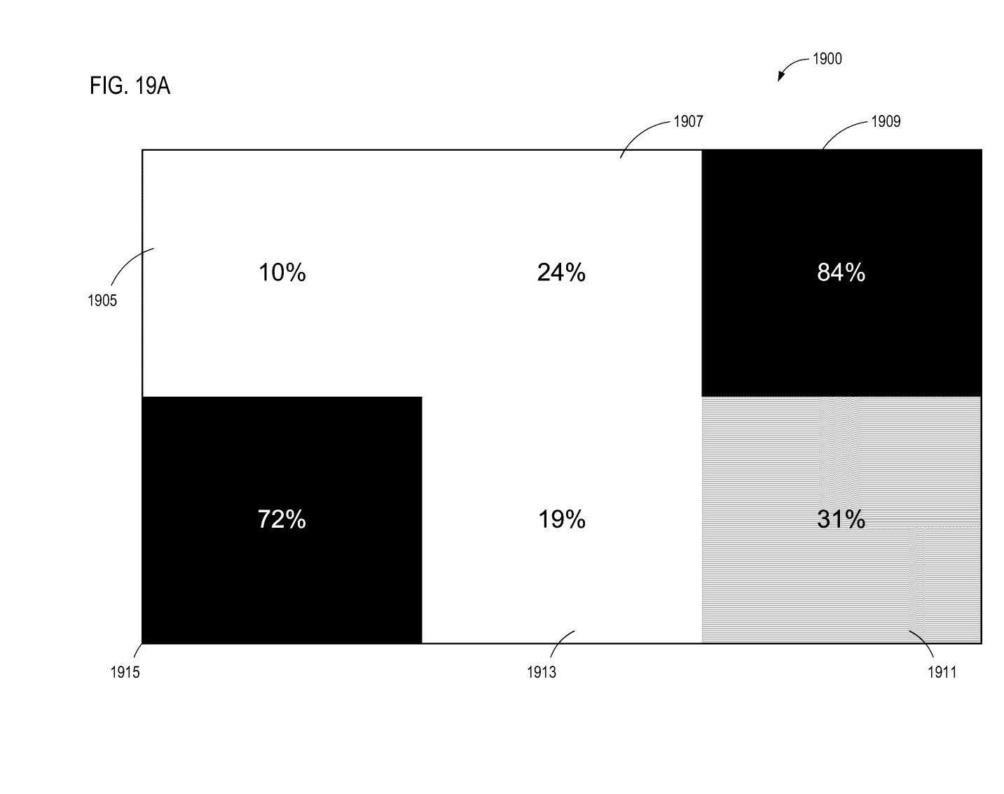

FIG. 18 illustrates a method for resolving ambiguities in an image using ultrasound and electromagnetic radiation. The method steps are provided in no particular order and may be rearranged as would be technically feasible. A dual modality positioning system may transmit 1805 ultrasound into a region bounded by at least one surface. The dual modality positioning system may receive 1807 direct or rebounded ultrasonic reflections from at least one object within the region. Using the received ultrasonic reflection, the dual modality positioning system may generate 1809 image data of the object. The image data generated using the received ultrasonic reflection may include at least one ambiguity, such as a ghost image. The dual modality positioning system may receive 1811 electromagnetic radiation from the object that is sufficient to resolve the ambiguity. The dual modality positioning system may generate 1813 enhanced image data that resolves the ambiguity based on the received electromagnetic radiation. Optionally, the system may also determine 1815 a kinematic value associated with the portion of interest and/or modify 1817 the state of an entertainment device based on the kinematic value.

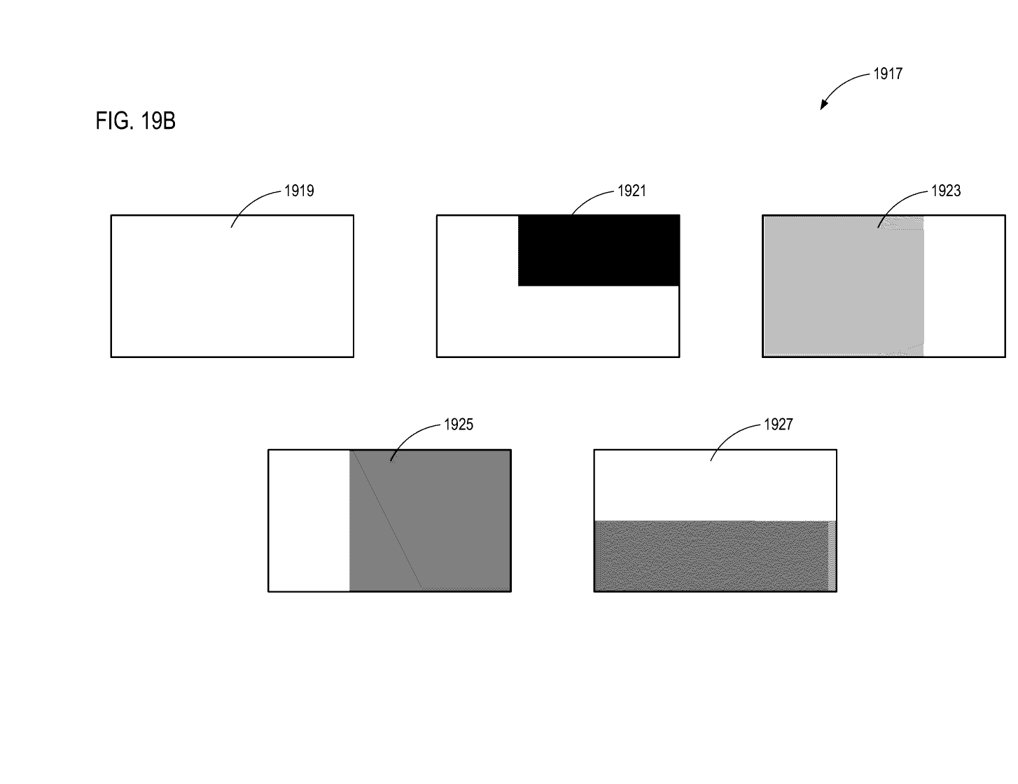

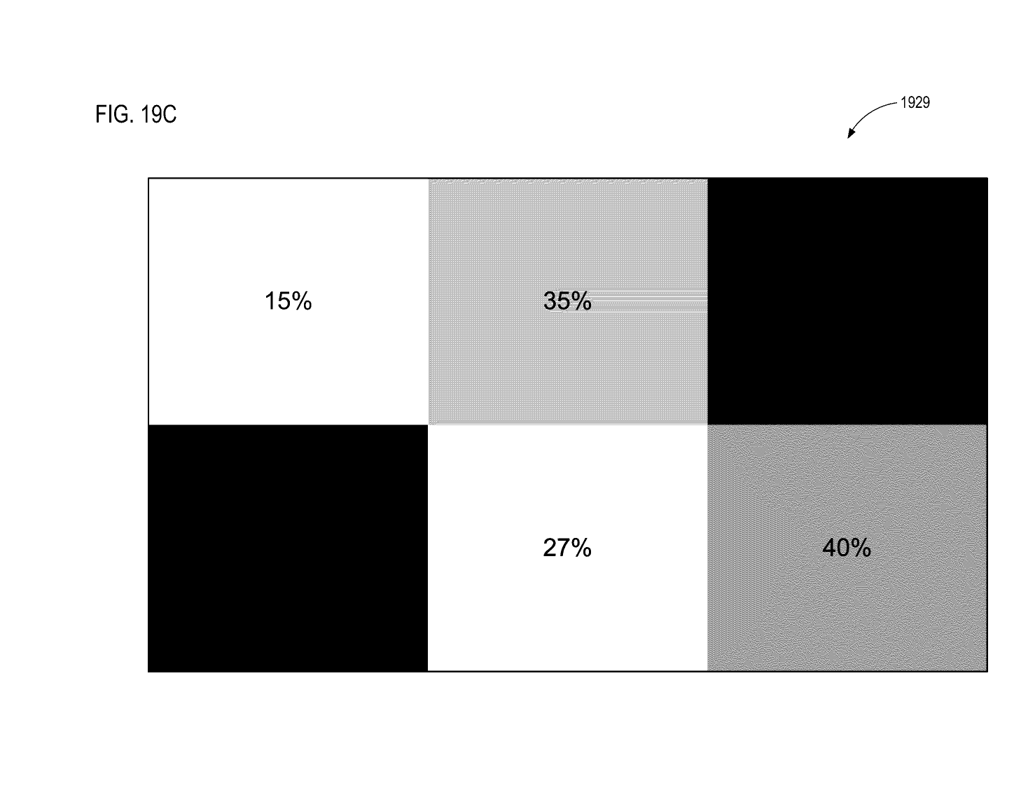

FIG. 19A illustrates one example of a six pixel image of an area of interest 1900. Each pixel (i.e., pixels 1905, 1907, 1909, 1911, 1913, 1915) represents the average color saturation in that portion of the region of interest. The pixels combine to form a representative image of an area of interest 1900. The representative image of an area of interest 1900 may contain any number of pixels. For example, as shown, the area of interest 1900 may be partitioned into six pixels. The pixels may be represented as color or in a grayscale, and may be generated using ultrasound, electromagnetic radiation, or a combination thereof.

In one embodiment, a sensor with multiple pixels may be used to capture the representative image of an area of interest 1900. For example, a sensor with six pixels may have captured the representative image of the area of interest 1900. However, such multi-pixel sensors may be expensive, and/or create significant processing burdens.

Therefore, to create a less expensive system, another embodiment may utilize a one-pixel sensor. The one-pixel sensor may be used to capture each portion of the area of interest individually. For example, the one-pixel sensor may first capture pixel 1905, then pixel 1907, then pixel 1909, then pixel 1911, then pixel 1913, and finally pixel 1915. The systems processor would then combine the pixels to form the representative image. However, this process may be even more taxing on the processor than using a multi-pixel sensor.

Therefore, in order to use less processing power, the six pixel image of the area of interest 1900 may be approximated using compressed sensing techniques. This approximation may be completed using multiple smaller images at a lower resolution.

For example, FIG. 19B illustrates five single value image captures 1917 that may be used to approximate one higher resolution image. The illustration is one possible selection of five single value image captures 1917. Each single value image capture represents an average over a small portion of the area of interest.

Each of the five single value image captures 1917 is directed at a specific portion of the region of interest. As shown, these specific portions may overlap. The first capture 1919 represents an average over the top left portion of the region of interest. The second capture 1921 represents an average over the top right portion of the region of interest. The third capture 1923 represents an average over the left two-thirds of the region of interest. The fourth capture 1925 represents an average over the right two-thirds of the region of interest. The fifth capture 1927 represents an average over the bottom half of the region of interest.

A perfect approximation of the six pixel image requires at least six lower resolution image captures—one capture for each of the six pixels of the region of interest. However, a good approximation may be achieved with fewer than six single value images using compressed sensing techniques. For example, the five single value image captures 1917 can be used to approximate the six pixels of the area of interest 1900 in FIG. 19A by using the average color saturation of the overlapping areas.

FIG. 19C illustrates one possible approximation of the six pixel image 1929 using the five single value images 1917 from FIG. 19B. The approximation is close to the actual values of the six pixels, as provided in FIG. 19A. A good or adequate approximation of an image may be achieved using a small number of low resolution image captures, where each low resolution image capture represents a specific portion of the region of interest. In some embodiments, the compressed sensing techniques described herein may produce an approximation of an image that is indiscernible to a human viewer from a much higher resolution image. Similarly, an entertainment device or other processing system may utilize the images (e.g., electromagnetic or ultrasonic representations) of objects generated using the compressed sensing techniques described herein as adequate or even functionally equivalent substitutes for higher resolution image representations. This reduces the required sensitivity and/or number of sensors in a system. By reducing the required sensitivity and/or number of sensors in a system, low cost sensors may be used in place of sensors with a high sensitivity and/or fewer total sensors may be needed.

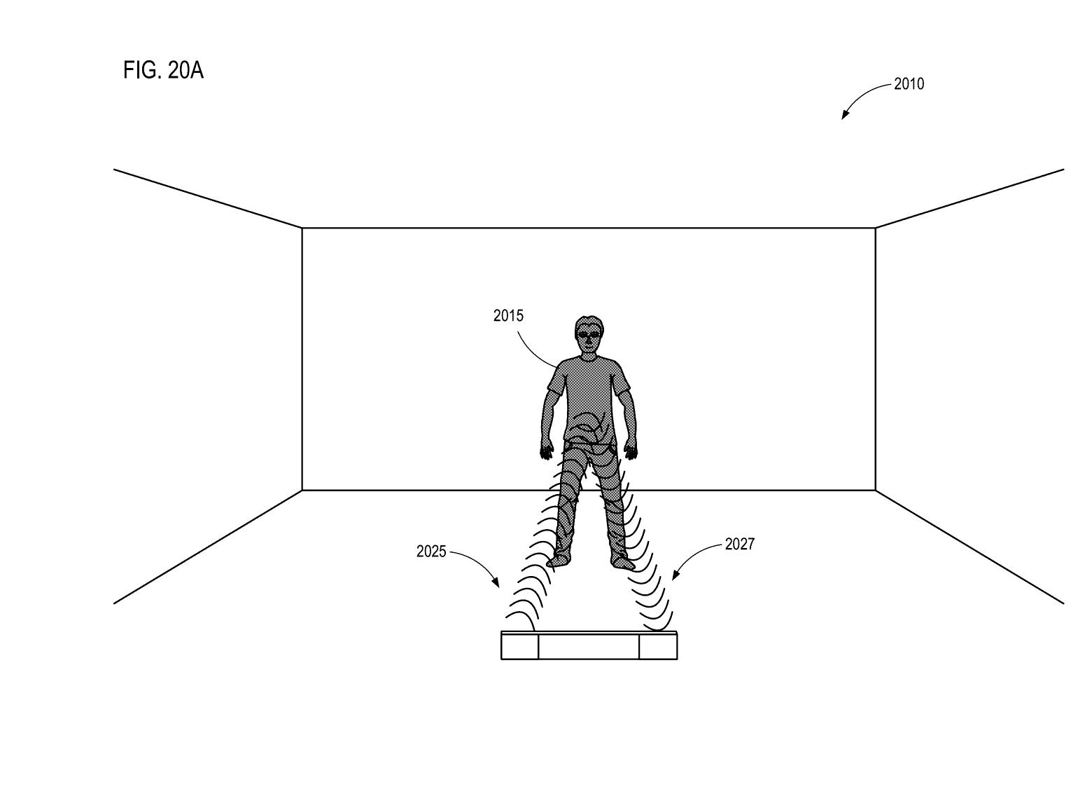

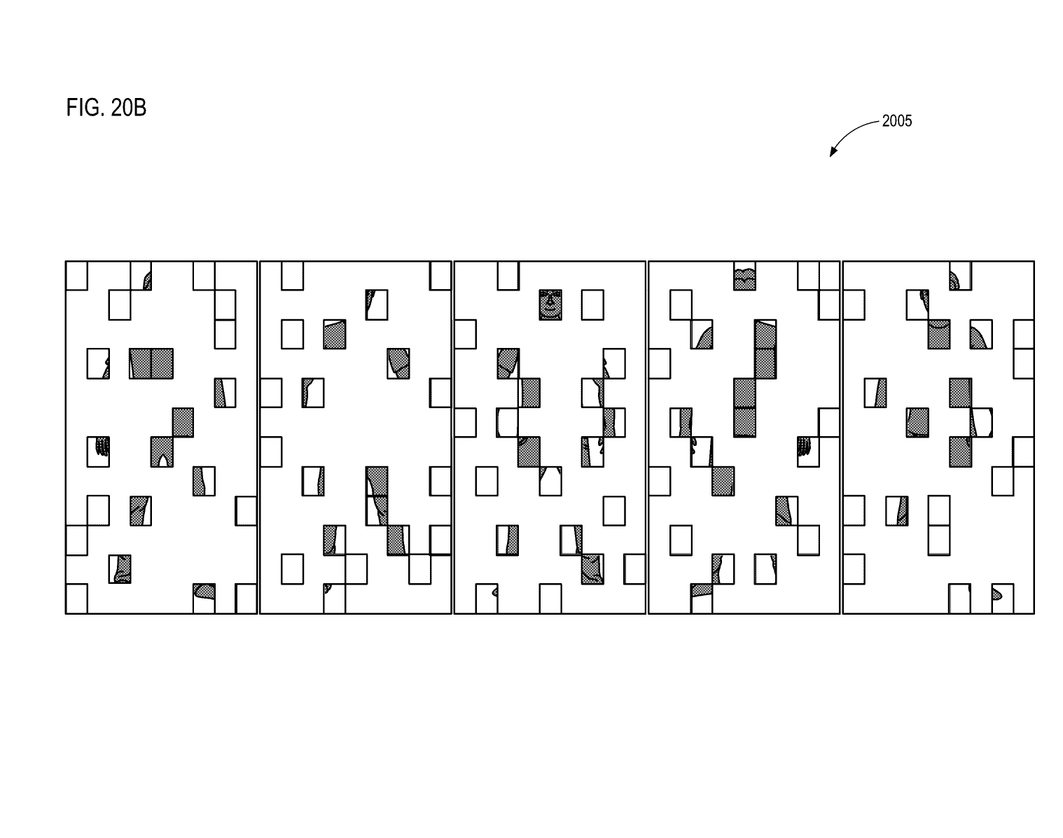

FIG. 20A illustrates a system 2010 that uses ultrasound 2025 and/or electromagnetic imaging techniques to create an image of a person 2015 in a region of interest. Multiple images of different portions of the region of interest may be generated using the received ultrasonic reflections 2027. In such an example, the image of the entire region of interest may be created by piecing or stitching multiple smaller images together. Each of the smaller images may be captured at the same resolution as the desired image over a smaller area. To complete the image of the region of interest, a smaller image must be captured from each portion of the image of the region of interest.

For example, FIG. 20B illustrates one example of the received images 2005. Multiple small images (i.e., image 2050, image 2052, image 2054, image 2056, image 2058) are received from various portions of the region of interest. These small images may be combined to form a single large image of the region of interest. Using this technique may require a large number of small images to complete an image of the entire region of interest. The large number of images may require significant processing power. This process is different from compressed sensing where an approximation of a region of interest may be achieved by combined a small number of low resolution images, potentially using significantly less processing power. In other embodiments the processing power may be irrelevant, but compressed sensing may be used for other distinguishing characteristics and advantages as are appreciated in the art.

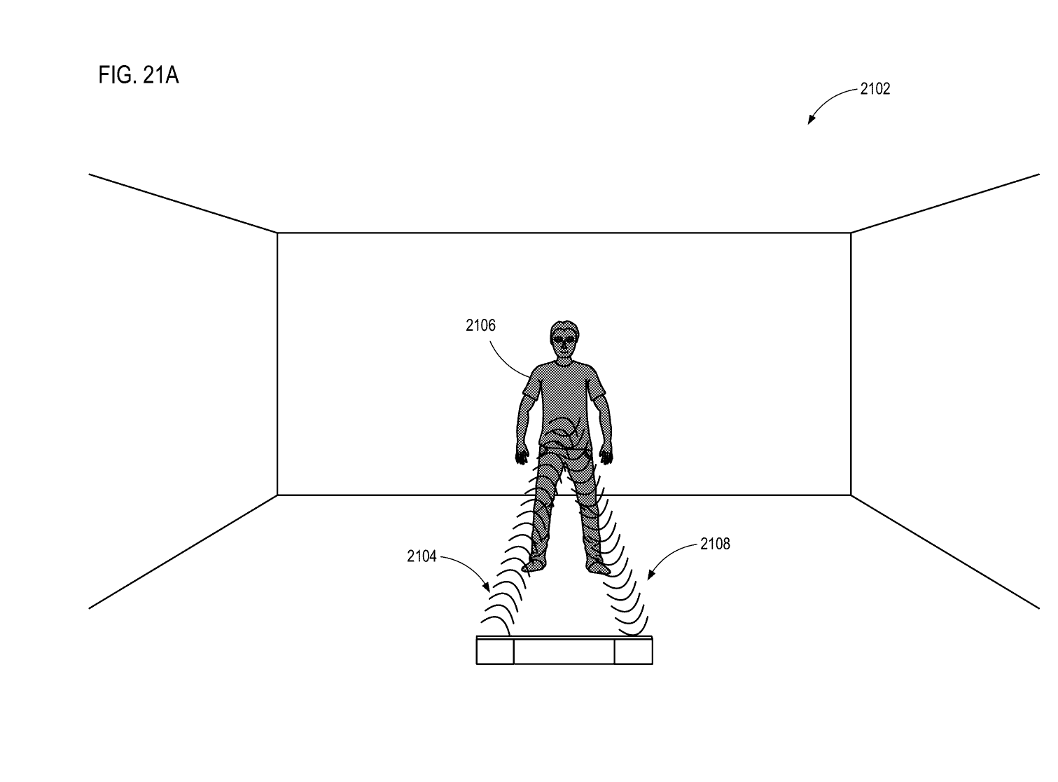

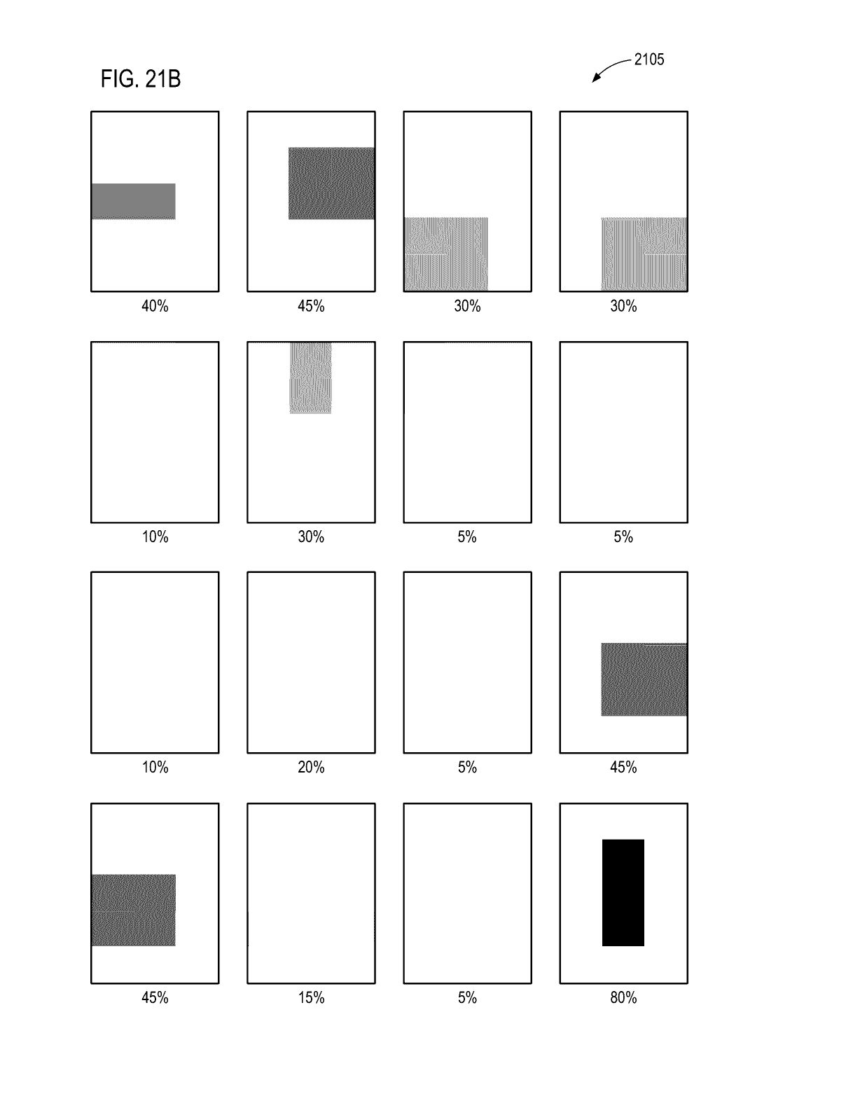

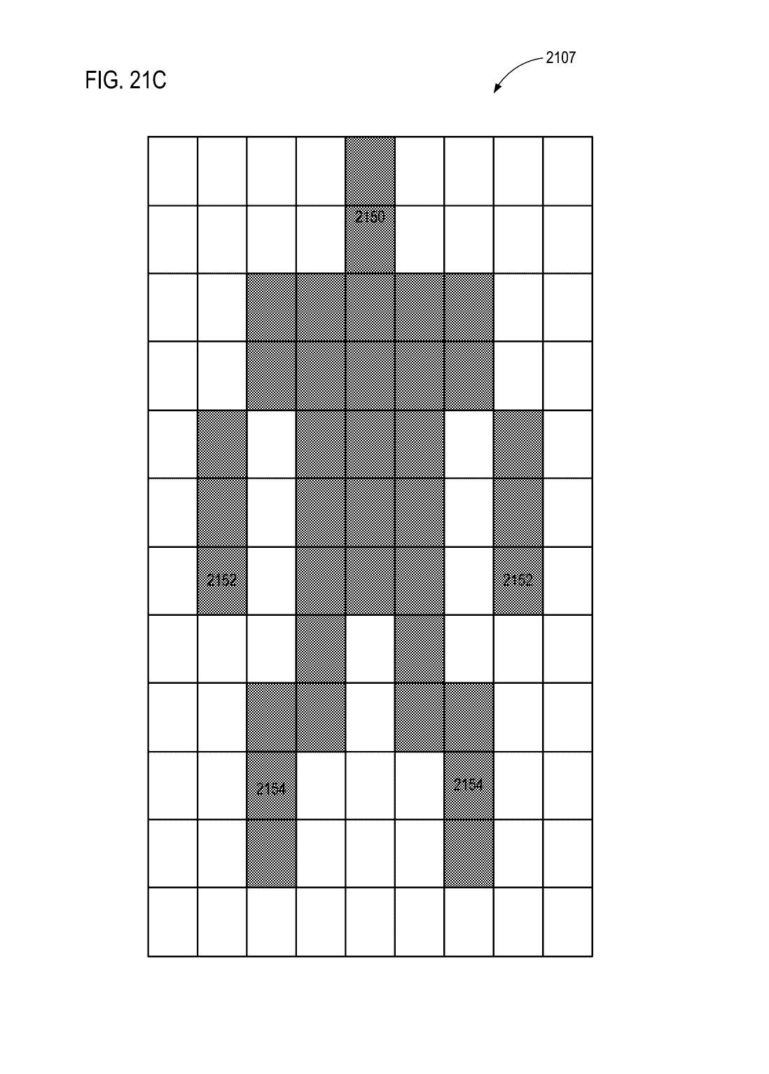

FIG. 21A illustrates a system that uses ultrasound 2104 and/or electromagnetic imaging techniques in combination with compressed sensing to create an image approximation of a person 2106 in a region of interest. Multiple single value image captures may be generated using the received ultrasonic reflections 2108. The multiple singe value image captures may be used to create an image approximation of the person 2106 in a region of interest

FIG. 21B illustrates one possible example of multiple single value image captures 2105. Each image capture represents the average value of a portion of a larger image 2102. FIG. 21B illustrates one possible representation of compressed sensing; it is not meant to limit the scope of the number, size, shape, order, or other characteristic of the image captures in a compressed sensing system in any way. The images may be captured in color, greyscale, or any other color space or chroma subsampling (e.g., 4:x:x).

Each image capture shows the average value of a portion of the larger image 2102. Small single value image captures are taken in overlapping sections of the larger image 2102. In some embodiments, the image captures may not be overlapping. The average value of each portion of the image is combined to approximate the value of the larger image 2102. The approximation of the larger image may be completed using relatively few lower resolution images. The small number of required single or low value images allows a large image to be approximated quickly and efficiently while requiring lower quality images for the reconstruction.

For example, the upper right corner of the larger image 2102 can be approximated using compressed imaging techniques. As illustrated, the upper right corner of the larger image 2102 is captured by two single value image captures (i.e., image capture 2110 and image capture 2112). As shown, image capture 2110 estimates the color saturation value as 5%, whereas image capture 2112 estimates the color saturation value as 10%. These image captures overlap in the upper right corner of the larger image 2102. Therefore, to estimate the color saturation value of the upper right corner of the larger image 2102 the two color saturation values may be averaged to 7.5%.

Other embodiments may use more single value image captures to approximate each pixel. Some examples may use different algorithms to approximate each pixel. For example, instead of simply averaging each single value image capture, some single value image captures may be weighted more than others in the approximation algorithm. For instance, if a sensing system were to capture a large area in one image and a small area in a second image, the second image may contain a closer value to the actual pixel. Therefore, the system may approximate the pixel closer to the second image.

FIG. 21C depicts one possible reconstruction of a larger high resolution image 2107 from multiple, small low resolution images, using compressed sensing techniques. The image shows how a higher resolution image may be approximated by averaging multiple lower resolution images 2105. The image is of sufficient quality to show areas of interest. For example, it is possible to see where the head 2150, arms 2152, and legs 2154 of the person are located. This shows how compressed sensing may be used to create a higher resolution image from multiple lower resolution images.

A more detailed image of areas of interest may be obtained by using additional low resolution images. In certain circumstances it may be advantageous to create a detailed picture. In other examples, a less detailed image, requiring less processing power, is sufficient.

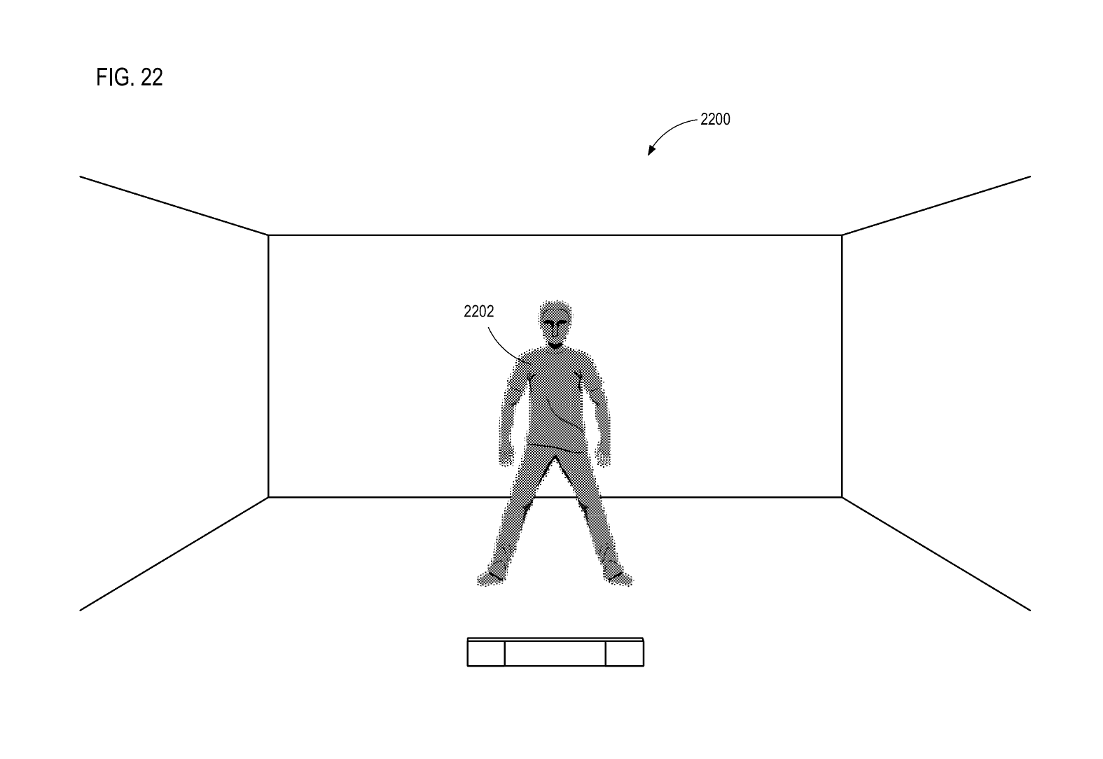

FIG. 22 illustrates how an image 2200 that was created using compressed sensing may appear. It may be seen that the resolution of the image is sufficient to determine multiple details about the person 2202 in the image. For example, details may be seen in the hands, feet, and face of the person 2202. This is sufficient resolution for the image to be useful. For example, an image of such quality may be used to gather data in entertainment systems.

Further, the compressed sensing may be used for the whole area of interest or portions of the area of interest. For example, a state of the associated entertainment device may utilize a hand movement for a particular action. In such an example, the compressed sensing system may determine the location of the user's hands with ultrasound or electromagnetic radiation. Upon the determination, the sensor system may use compressed sensing to create a more detailed image of the user's hand. In addition, the compressed sensing system may be adaptive.

For example, in certain embodiments, the compressed sensing system may detect the movement of a user's hand and identify where the hand has moved with ultrasound or electromagnetic radiation, and use compressed sensing to create a detailed image of the hand in the new place. Other embodiments may utilize, detect, and capture a user's feet, leg, arm, body, and/or facial movements with the compressed sensing techniques described above.

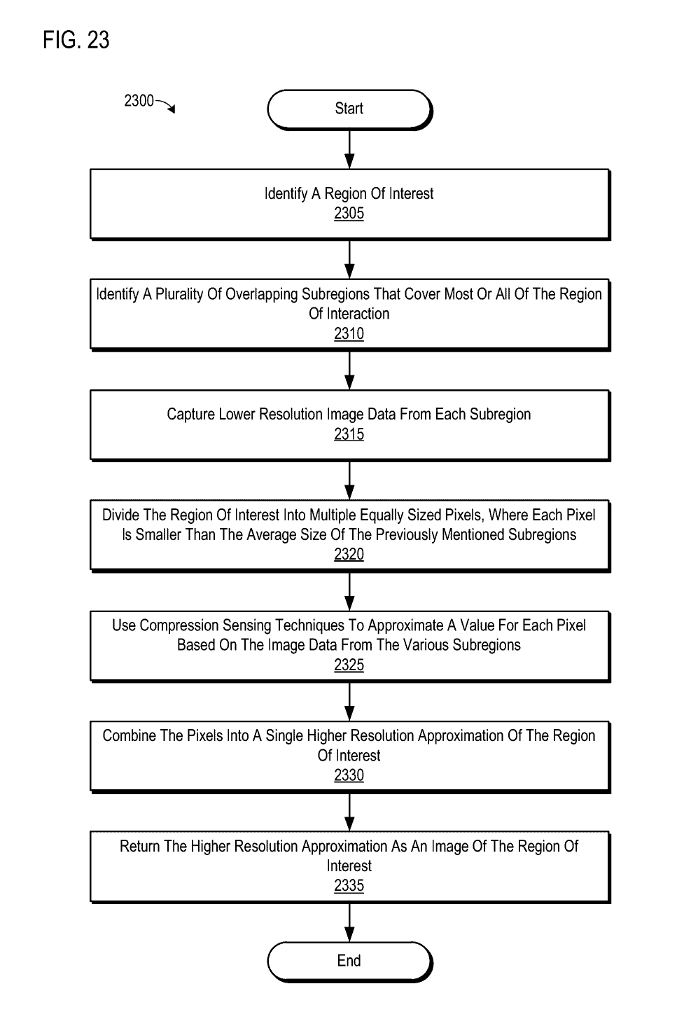

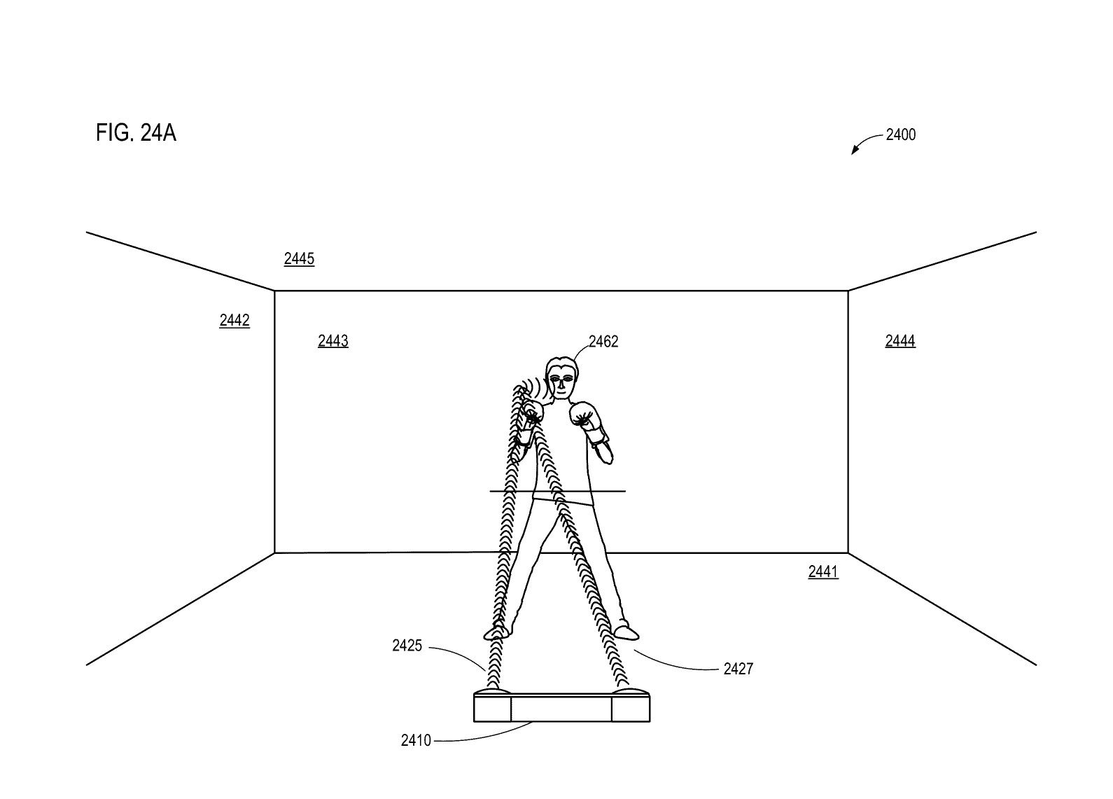

FIG. 23 illustrates a method 2300 for using compressed sensing to generate image data. The steps are in no particular order and may be rearranged as is technically feasible. A compressed sensing system may identify a region of interest 2305. The system may identify a plurality of subregions 2310 that collectively cover all or most of the region of interest. The subregions may be of varying sizes. Lower resolution image data may be captured from each of the subregions 2315. The image data may be represented as color or grayscale. The region of interest 2305 may be divided into multiple equally sized pixels 2320 where the average pixel size is smaller than the size of the previously mentioned subregions 2310. Compressed sensing techniques may be used to assign values to each of the pixels 2325 in the region of interest 2305. The pixels may be combined to form a single higher resolution approximation 2330 of the region of interest 2305. The higher resolution approximation 2330 may be returned a higher resolution image 2335 of the region of interest.

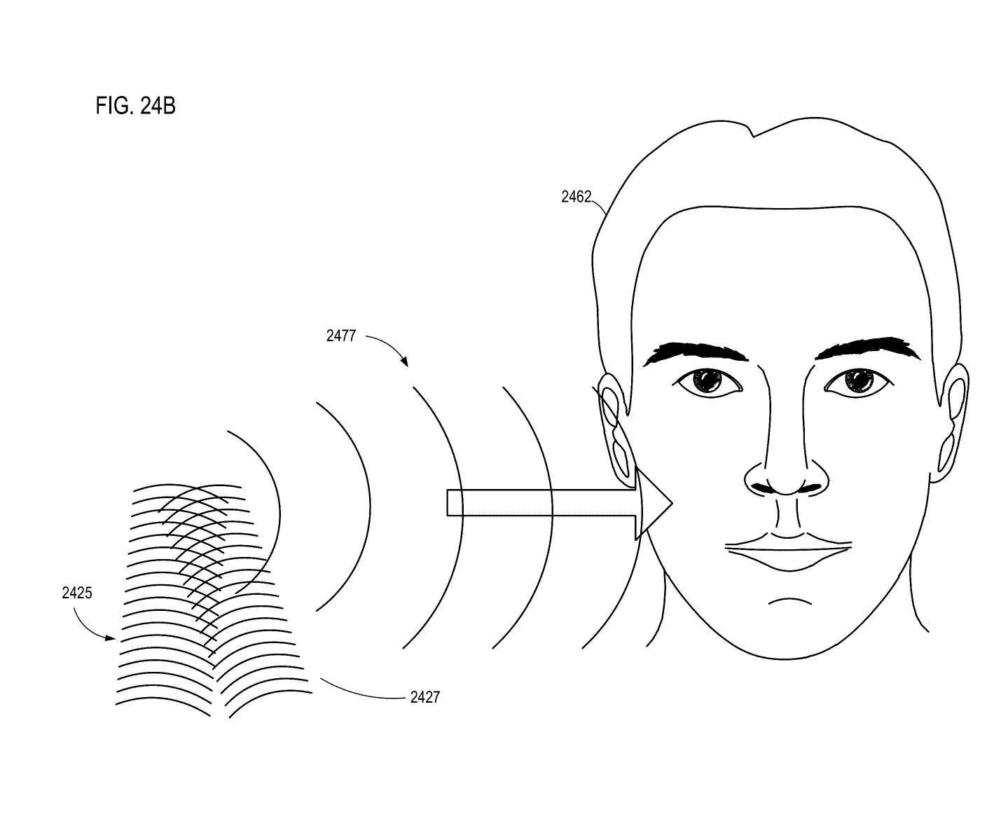

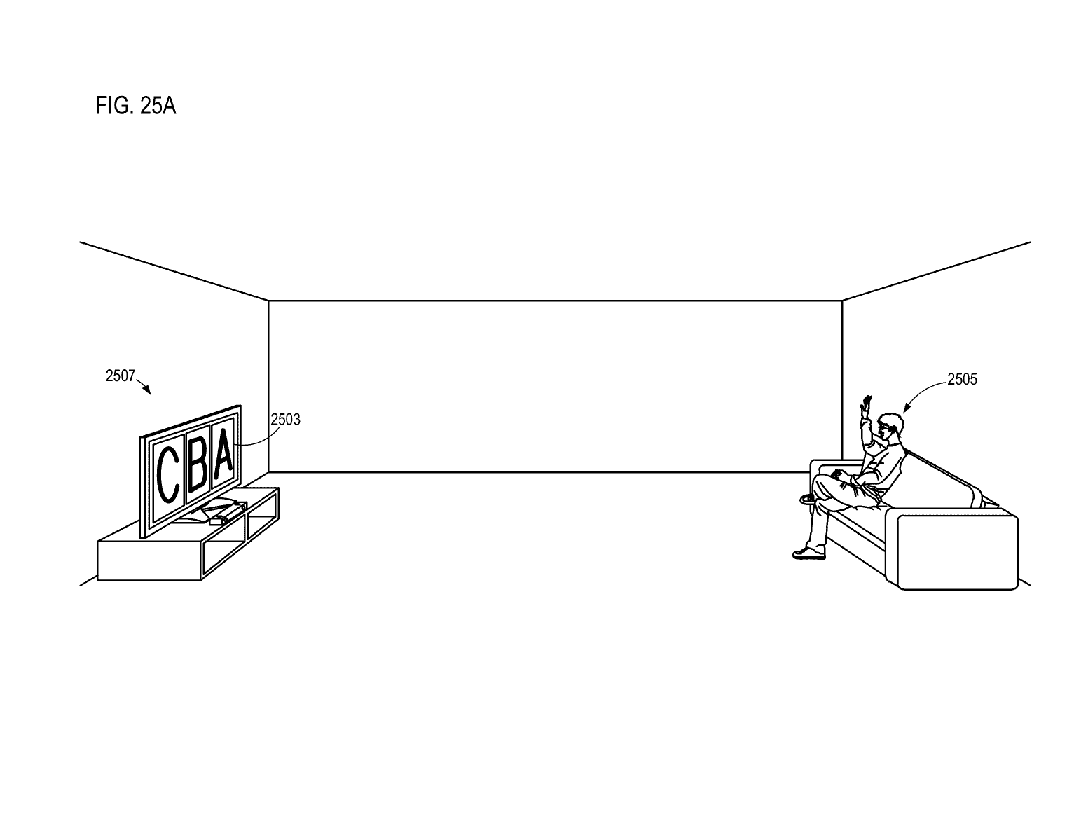

FIG. 24A illustrates a parametric ultrasonic transmitter subsystem 2410 for providing induced tactile stimuli to a user 2462 of an entertainment system. The subsystem 2410 provides induced haptic sensation such as tactile stimuli by focusing a first ultrasonic pulse 2425 and a second ultrasonic pulse 2425 towards a point proximate to the user 2462 of the entertainment system. The nonlinear interaction of the ultrasonic pulses 2425 and 2427 at that point may generate a low frequency pulse at a beat frequency of the two original ultrasonic pulses 2425 and 2427. The generated pulse may be felt by a user as a tactile sensation or a touch since it is at a relatively low frequency (e.g., 10 Hz to 500 Hz).

In some instances the generated pulse may be audible to the user of the system. In other instances the pulse may only be felt and not heard by the user 2462. The induced tactile stimuli may provide the user with a feeling of enhanced interaction with the entertainment system. For example, if the user were interacting with a video game for simulating boxing, the system may use induced tactile stimuli to inform the user 2462 if his or her opponent had scored a hit. In addition the induced tactile stimuli may be calibrated to simulate various other tactile sensations (e.g., a touch, an impulse, a brush, or a kinesthetic sensation). The induced tactile stimuli may also be adjusted to target sites of interest on or in the user.

For example, the induced tactile stimuli may be directed toward the user's hands, fingers, arms, legs, toes, feet, head, ears, lips, nose, and/or some other region of interest depending on the application of the entertainment system. The variation in feedback may create a more diverse interaction between the user and the entertainment system. In some instances or embodiments the system may target the user's feet to inform the user when to step in an exercise game.

In some embodiments the system may target a user's 2462 fingers to simulate playing a musical instrument. In still other embodiments the system may use induced tactile stimuli to give the user 2462 a sense of motion during a driving simulation. These examples are intended to be illustrative and not limiting. That is, the examples provided herein are meant to demonstrate multiplicity of applications that may utilize and/or benefit from induced haptic sensations, such as tactile stimuli, to enhance the interaction between an entertainment system and a user 2462.

FIG. 24B illustrates the generation of a pulse 2477 used for induced tactile stimuli to the user 2462 of an entertainment system. The pulse 2477 is generated by the nonlinear interaction of two ultrasonic pulses 2425 and 2427. The first ultrasonic pulse 2425 is directed along a vector relative to the user 2462 and the second ultrasonic pulse 2427 is directed along a similar vector relative to the user 2462. The two vectors intersect at a point proximate the user 2462; this point can be in air near the user, in body tissue of the user, in material worn by the user, or in a device worn by the user. Ultrasonic pulses 2425 and 2427 behave nonlinearly in air and tissue which facilitates the generation of a new low frequency pulse 2477 at a beat frequency of the original ultrasonic pulses 2425 and 2427.

The beat frequency of interest may, for example, be the magnitude of the difference of the two ultrasonic pulses 2425 and 2427. In addition, the amplitude, phase, frequency and/or duration of the generated pulse 2477 may be adjusted by adjusting either the first 2425 or second 2427 ultrasonic pulse. If the generated pulse 2477 is at a frequency that can be felt by a human, e.g., via human skin, it may be used to provide induced haptic stimulation (e.g., tactile stimuli) to a user of an entertainment system.

For example, the user 2462 may engage in a driving simulation on an entertainment system. Induced haptic sensations may be used to provide a sense of motion to the user, e.g., to simulate a turn, wind resistance, and/or other haptic sensations connected with driving.

There may be embodiments where multiple users interact virtually through the entertainment system display interface. The system may provide haptic sensations to each player if they score a point, or the system may induce haptic sensations to provide feedback when a user loses a life or engages another player. It may even be possible for players to direct haptic sensations towards one another during the course of, or as part of, a game.

Other embodiments may interact similarly with a single user. For example, if the user engaged in a boxing simulation, the entertainment system may use haptic feedback to notify the user of contact by his opponent. This may cause the user 2462 to feel a heightened sense of interaction with the simulation presented by the entertainment system.

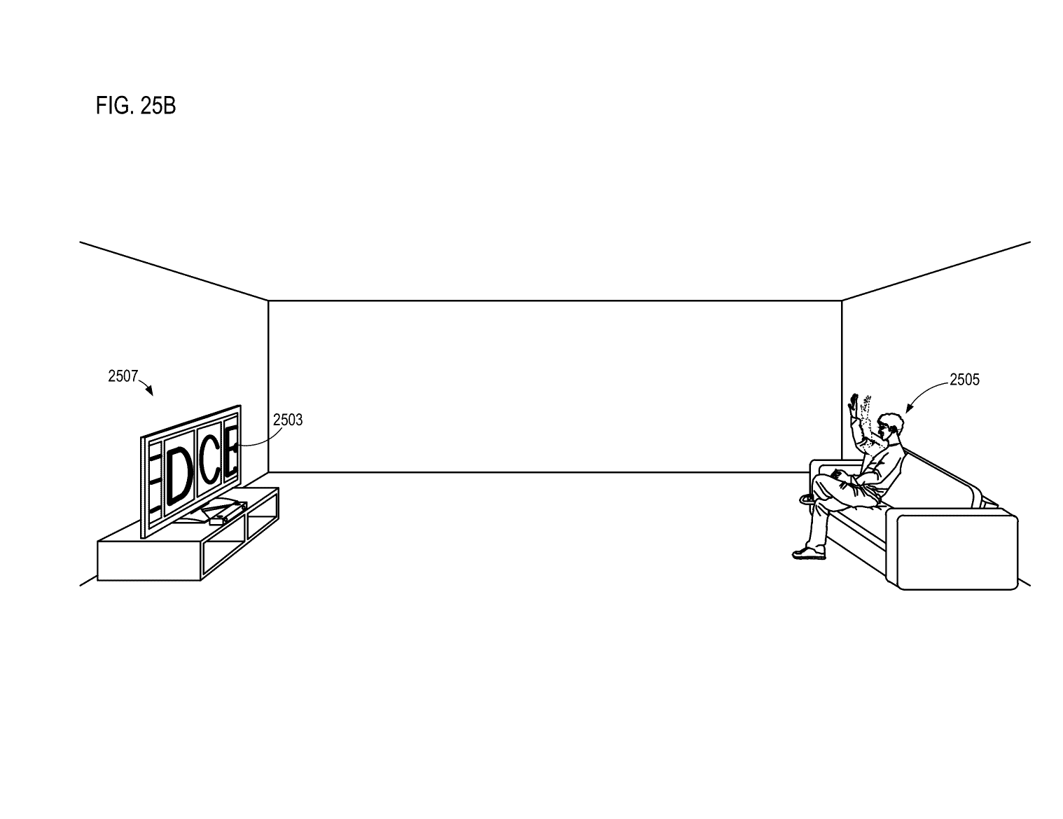

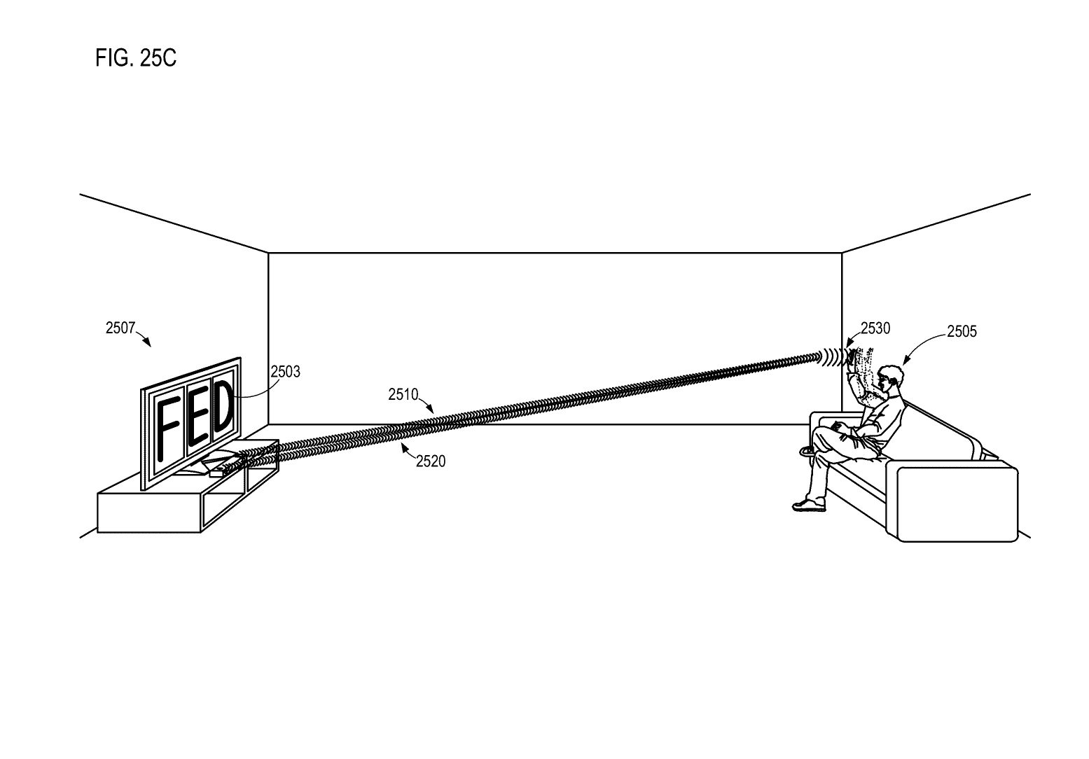

FIG. 25A illustrates a user 2505 initiating interaction with an entertainment system 2507. The system 2507 may be able to detect the location and position of the user 2505 through various subsystems. In addition, the system 2507 may identify sites of interest on the user 2505 such as the user's 2505 hands, arms, fingers, head, eyes, nose, lips, and/or feet. By identifying and monitoring sites of interest the entertainment system 2507 may be able to detect when the user 2505 performs certain gestures or movements. Depending on the performed gesture or movement, the entertainment system 2507 may enter different states or interact differently with the user 2505.

For example, the user 2505 is depicted in FIG. 25A as waving at the entertainment device interface 2507. This may prompt the device to enter an options menu where the user 2505 may, as a specific example, select a car to drive in a simulation. In other instances or embodiments the entertainment system 2507 may respond to other gestures or movements. The system 2507 may respond to motions such as waving, punching, clapping, stomping, moving the fingers and/or any other motion convenient or pertinent to the interaction between the user and the entertainment system.

For example, the system 2507 may in some embodiments “wake up” from a standby mode when the user 2505 claps. The system 2507 may track the motion of the user's 2505 eyes to determine where the user 2505 is looking on the displayed image 2503. The system 2507 may at times interact with the user 2505 differently depending on whether the user 2505 is standing or sitting.

FIG. 25B illustrates the user 2505 virtually interacting with the entertainment device interface 2501. In this embodiment as the user 2505 moves his hand the entertainment system 2507 tracks the motion of the hand and updates an options menu accordingly (e.g., a swiping motion to navigate through a series of menu options). In this way the user 2505 is able to interact with the displayed image 2503 from the entertainment display interface 2501. In other embodiments, the system 2507 may interact differently with the user 2505. For example, in some instances the menu may move downward instead of from side to side. Other gestures may be used for item selection in the menu. In some instances the gestures and interactions may be specific to a particular activity or game.

In some embodiments, the system 2507 may display a video or movie, and certain gestures, such a waving or pointing, may be used to pause, play, fast forward, rewind, or stop the video. During the course of a video game, similar actions may be mapped to swinging a baseball bat or engaging an opponent. Haptic sensations may be provided to the user as feedback and/or as part of the interaction.

FIG. 25C illustrates the entertainment system 2507 providing induced tactile stimuli to the user 2505. In this embodiment the induced tactile stimuli was provided when the user 2505 reached the end of the options menu. The induced tactile stimuli may be provided by creating a sensation of touch on the user's 2505 hand. Providing induced tactile stimuli to the user 2505 in this way informs the user 2505 that the menu is at an end. If no feedback were provided, the user 2505 might assume that the entertainment system is malfunctioning or unresponsive. By providing feedback at the end of the menu, the user 2505 may feel as well as see that the menu has ended. An entertainment system 2507 that provides both visual and haptic (i.e., tactile or kinesthetic) interaction with the user 2505 may enhance the quality of the user's 2505 experience with the entertainment system.

The induced haptic sensation (e.g., tactile stimulation) may be generated using any of the various embodiments or combinations thereof that are discussed herein. As illustrated, two ultrasonic pulses 2510 and 2520 are transmitted and mix near or at a site (the hand) of the user. The mixing results in a lower frequency acoustic signal 2530 at a beat frequency of the two ultrasonic pulses 2510 and 2520. The lower frequency acoustic signal 2530 induces a haptic sensation at the hand of the user to provide contextual information relating to the on-screen display and/or the user's interaction therewith.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. The scope of the present invention should, therefore, be determined by the following claims:

1. A system for providing haptic feedback to a user of an entertainment device, comprising:
a radiation receiver configured to receive radiation reflected by a user located within a region;
a position module configured to identify a position of the user relative to the region using the received radiation reflections;
an identification module configured to identify a site of the user suitable for receiving haptic feedback based on a state of the entertainment device; and
a parametric ultrasonic transmitter subsystem configured to:
transmit a first ultrasonic pulse along a first vector relative to the user; and
transmit a second ultrasonic pulse along a second vector relative to the user,
wherein the first ultrasonic pulse and the second ultrasonic pulse are configured to intersect proximate the identified site of the user and generate an acoustic wave at a beat frequency of the first and second ultrasonic pulses, and
wherein the acoustic wave at the beat frequency is configured to induce a haptic sensation at the identified site of the user.

2. The system of claim 1, further comprising a radiation transmitter configured to transmit radiation into the region.

3. The system of claim 1, further comprising a kinematic module configured to calculate a kinematic value associated with the identified site of the user.

4. The system of claim 1, wherein the haptic sensation comprises a tactile stimulus to the identified site of the user.

5. The system of claim 1, wherein the haptic sensation comprises a kinesthetic sensation.

6. The system of claim 1, wherein the haptic sensation comprises tactile sensation configured to feel like a touch.

7. The system of claim 1, wherein the haptic sensation comprises stimuli on the skin of the user.

8. The system of claim 1, wherein the haptic sensation comprises an impulse delivered to a fingertip of the user.

9. (canceled)

10. The system of claim 1, wherein the entertainment device comprises at least one of a television, a game console, a video streaming device, a database browsing device, an internet browsing device, a public computing device, and a personal computing device.

11. (canceled)

12. The system of claim 2, wherein the radiation transmitter comprises an electromagnetic radiation transmitter configured to transmit electromagnetic radiation, and
wherein a radiation receiver comprises an electromagnetic radiation receiver configured to receive electromagnetic radiation.

13. The system of claim 12, wherein the electromagnetic radiation comprises infrared radiation.

14. The system of claim 12, wherein the electromagnetic radiation comprises visible light.

15-23. (canceled)

24. The system of claim 2, further comprising at least one auxiliary radiation reflector configured to rebound radiation transmitted by the radiation transmitter.

25. The system of claim 24, wherein the auxiliary radiation reflector comprises one of a wall, floor, and ceiling bounding the region.

26-27. (canceled)

28. The system of claim 2, further comprising a shift calculation module configured to calculate a frequency shift of the received radiation relative to the transmitted radiation.

29. The system of claim 2, further comprising a shift calculation module configured to calculate a timing or phase shift of the received radiation reflection relative to the transmitted radiation.

30-41. (canceled)

42. The system of claim 2, wherein transmitting radiation comprises transmitting one or more directional ultrasonic pulses.

43-48. (canceled)

49. The system of claim 1, further comprising a kinematic module configured to calculate a plurality of kinematic values for each of a plurality of sites of the user.

50. The system of claim 49, wherein the plurality of kinematic values are used to determine a translational velocity of a site of the user.

51. The system of claim 49, wherein the plurality of kinematic values are used to determine an angular velocity of a site of the user.

52-60. (canceled)

61. The system of claim 1, wherein the identification module is configured to identify a site of the user that comprises a portion of a person selected from the group consisting of a hand, finger, arm, leg, foot, toe, torso, neck, head, mouth, lip, and eye.

62. A method for providing haptic feedback associated with the usage of an entertainment device, comprising:
receiving, via a radiation receiver, radiation reflected by a user located within a region;
generating positional data that identifies a position of the user relative to the region using the received radiation reflections;
identifying a site of the user suitable for receiving haptic feedback;
transmitting a first ultrasonic pulse along a first vector relative to the user;
transmitting a second ultrasonic pulse along a second vector relative to the user, wherein the first ultrasonic pulse and the second ultrasonic pulse are configured to intersect proximate the identified site of the user and generate an acoustic wave at a beat frequency of the first and second ultrasonic pulses; and
selecting frequencies of the first and second ultrasonic pulses such that the frequency of the acoustic wave induces a haptic sensation at the identified site of the user based on a state of an entertainment device.

63. The method of claim 62, further comprising transmitting radiation, via at least one radiation transmitter, into the region.

64. (canceled)

65. The method of claim 62, further comprising calculating a kinematic value associated with the identified site of the user.

66-86. (canceled)

87. The method of claim 63, wherein at least one of the transmitted radiation and the received reflected radiation are rebounded from an auxiliary radiation reflector.

88. The method of claim 87, wherein the auxiliary radiation reflector comprises one of a wall, floor, and ceiling bounding the region.

89. The method of claim 62, wherein a received radiation reflection is used in determining the relative position of the user within the region.

90. (canceled)

91. The method of claim 62, wherein the received radiation is used in determining a relative position of the user within the region.

92. The method of claim 91, wherein the radiation comprises at least one of ultrasonic radiation, microwave, terahertz, infrared, visible, and ultraviolet electromagnetic radiation.

93. The method of claim 63, further comprising calculating a frequency shift of the received radiation relative to the transmitted radiation.

94. The method of claim 63, further comprising calculating a timing or phase shift of the received radiation reflection relative to the transmitted radiation.

95. The method of claim 63, further comprising calculating a wavelength shift of the received radiation reflection relative to the transmitted radiation.

96. The method of claim 62, wherein the state of the entertainment device corresponds to an interaction by the user with a displayed icon associated with the entertainment device.

97-99. (canceled)

100. The method of claim 62, wherein the state of the entertainment device corresponds to a state in which a user is a first player in a video game being affected by another player of the video game.

101. The method of claim 62, wherein the state of the entertainment device corresponds to a state in which a user is making virtual contact with a displayed image, such that the haptic feedback corresponds to the virtual contact.

102-103. (canceled)

104. The method of claim 65, further comprising:
receiving, via a second radiation receiver of the radiation receiver system that is physically separated from the first radiation receiver, a radiation reflection from the user;
detecting a shift of the radiation reflection received by the second radiation receiver; and
calculating, via the processor, a second kinematic value associated with the user based on the detected shift of the radiation reflection received by the second radiation receiver.

105. The method of claim 104, further comprising:
receiving, via a third radiation receiver of the radiation receiver system that is physically separated from the first radiation receiver, a radiation reflection from the user;
detecting a shift of the radiation reflection received by the third radiation receiver; and
calculating, via the processor, a third kinematic value associated with the user based on the detected shift of the radiation reflection received by the third ultrasonic receiver.

106. The method of claim 105, further comprising:
predicting a relative position of the identified site of the user at a future time based on (1) the first kinematic value associated with the user, (2) the second kinematic value associated with the user, and (3) the third kinematic value associated with the site of interest on the user.

107-119. (canceled)

120. The method of claim 62, further comprising calculating a plurality of kinematic values for each of a plurality of sites of the user.

121-131. (canceled)

132. A non-transitory computer-readable medium having instructions that, when executed by a processor, cause the processor to perform operations for generating image data of an object within a region, the operations comprising:
receiving, via a radiation receiver, radiation reflected by a user located within the region;
generating positional data that identifies a position of the user relative to the region using the received radiation reflections;
identifying a site of the user suitable for receiving haptic feedback;
transmitting a first ultrasonic pulse along a first vector relative to the user;
transmitting a second ultrasonic pulse along a second vector relative to the user, wherein the first ultrasonic pulse and the second ultrasonic pulse are configured to intersect proximate the identified site of the user and generate an acoustic wave at a beat frequency of the first and second ultrasonic pulses; and
selecting frequencies of the first and second ultrasonic pulses such that the frequency of the acoustic wave induces a haptic sensation at the identified site of the user based on a state of an entertainment device.
